(19) United States
(12) Patent Application Publication
(10) Pub. No.: US 2026/0129381 A1
(43) Pub. Date: May 7, 2026

(54) STATE INFORMATION EXCHANGE AMONG CONNECTED DEVICES

(71) Applicant: Sonos, Inc., Goleta, CA (US)

(72) Inventors: Steven Beckhardt, Santa Barbara, CA (US); Luis Vega-Zayas, Cambridge, MA (US); Ted Lin, Goleta, CA (US); Jonathan Herbst, Goleta, CA (US)

(21) Appl. No.: 19/117,004

(22) PCT Filed: Sep. 29, 2023
(86) PCT No.: PCT/US2023/034181

§ 371 Date: Mar. 28, 2025

Related U.S. Application Data
(60) Provisional application No. 63/377,948, filed on Sep. 30, 2022.
(60) Provisional application No. 63/377,967, filed on Sep. 30, 2022.
(60) Provisional application No. 63/377,978, filed on Sep. 30, 2022.
(60) Provisional application No. 63/377,979, filed on Sep. 30, 2022.
(60) Provisional application No. 63/377,899, filed on Sep. 30, 2022.
(60) Provisional application No. 63/502,347, filed on May 15, 2023.
(60) Provisional application No. 63/513,735, filed on Jul. 14, 2023.

(51) Int. Cl. H04R 27/00; H04N 21/436

(52) U.S. Cl. CPC H04R 27/00; H04N 21/43615; H04R 2227/005

(57) ABSTRACT

A system comprises a plurality of playback devices. Each playback device comprises one or more processors; and one or more storage devices that comprise instruction code that is executable by at least one of the one or more processors. Instruction code executed by one or more processors of a particular primary playback device (PPD) causes the particular PPD to: receive state information from a particular secondary playback device (SPD). The state information specifies a state associated with at least one aspect of the particular SPD. After receiving a subscription from one or more other PPDs for the state of the particular aspect of the particular SPD, the particular PPD communicates the state information that specifies the state of the particular aspect of the particular SPD to the one or more other PPDs.

### CROSS REFERENCE TO RELATED APPLICATIONS

This application claims priority to (i) U.S. Provisional App. 63/377,978, titled “Broker/Subscriber Model for Information Sharing and Management Among Connected Devices,” filed on Sep. 30, 2022; (ii) U.S. Provisional App. 63/377,979, titled “Multiple Broker Deployment for Information Sharing and Management Among Connected Devices,” filed on Sep. 30, 2022; (iii) U.S. Provisional App. 63/513,735, titled “State Information Exchange Among Connected Devices,” filed on Jul. 14, 2023; (iv) U.S. Provisional App. 63/377,899, titled “Multichannel Content Distribution,” referred to as Docket No. 22-0207p (0400042), filed on Sep. 30, 2022; (v) U.S. Provisional App. 63/377,948, titled “Playback System Architecture,” referred to as Docket No. 21-0703p (0401247), filed on Sep. 30, 2022; (vi) U.S. Provisional App. 63/377,967, titled “Playback Systems with Dynamic Forward Error Correction,” referred to as Docket No. 22-0401p (0403973), filed on Sep. 30, 2022; (vii) U.S. Provisional App. 63/502,347, filed May 15, 2023, and titled “Area Zones.” The entire content of these applications is incorporated herein by reference in its entirety.

Aspects of the features and functions disclosed and described in the above-identified applications can be used in combination with the examples disclosed and described herein and with each other in some instances to improve the functionality and performance of playback systems including playback systems having large numbers of playback devices.

### FIELD OF THE DISCLOSURE

The present disclosure is related to consumer goods and, more particularly, to methods, systems, products, features, services, and other elements directed to media playback systems, media playback devices, and aspects thereof.

### BACKGROUND

Options for accessing and listening to digital audio in an out-loud setting were limited until 2002 when SONOS, Inc. began development of a new type of playback system. Sonos then filed one of its first patent applications in 2003, titled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), individuals can play most any music they like in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a partial cutaway view of an environment having a media playback system configured in accordance with aspects of the disclosed technology.

FIG. 1B shows a schematic diagram of the media playback system of FIG. 1A and one or more networks.

FIG. 1C shows a block diagram of a playback device.

FIG. 1D shows a block diagram of a playback device.

FIG. 1E shows a block diagram of a network microphone device.

FIG. 1F shows a block diagram of a network microphone device.

FIG. 1G shows a block diagram of a playback device.

FIG. 1H shows a partially schematic diagram of a control device.

FIGS. 1-I through 1L show schematic diagrams of corresponding media playback system zones.

FIG. 1M shows a schematic diagram of media playback system areas.

FIG. 2A shows a front isometric view of a playback device configured in accordance with aspects of the disclosed technology.

FIG. 2B shows a front isometric view of the playback device of FIG. 3A without a grille.

FIG. 2C shows an exploded view of the playback device of FIG. 2A.

FIG. 3A shows a front view of a network microphone device configured in accordance with aspects of the disclosed technology.

FIG. 3B shows a side isometric view of the network microphone device of FIG. 3A.

FIG. 3C shows an exploded view of the network microphone device of FIGS. 3A and 3B.

FIG. 3D shows an enlarged view of a portion of FIG. 3B.

FIG. 3E shows a block diagram of the network microphone device of FIGS. 3A-3D

FIG. 3F shows a schematic diagram of an example voice input.

FIGS. 4A-4D show schematic diagrams of a control device in various stages of operation in accordance with aspects of the disclosed technology.

FIG. 5 shows front view of a control device.

FIG. 6 shows a message flow diagram of a media playback system.

FIG. 7A illustrates a system in which particular playback devices (PPDs) aggregate and propagate state information among playback devices of the system, in accordance with example embodiments.

FIG. 7B illustrates a system in which state aggregating devices (SADs) are primarily responsible for aggregating and propagating state information among the devices of the system, in accordance with example embodiments.

FIG. 7C illustrates a system in which SADS are associated with particular PPDs, in accordance with example embodiments.

FIGS. 8A and 8B illustrate the propagation of basic state information within a system, in accordance with example embodiments.

FIGS. 9A and 9B illustrate the propagation of group state information within a system, in accordance with example embodiments.

FIGS. 10A and 10B illustrate the propagation of battery state information within a system, in accordance with example embodiments.

FIGS. 11A and 11B illustrate the propagation of now-playing state information within a system, in accordance with example embodiments.

FIG. 12 illustrates the propagation of HTFreq state information within a system, in accordance with example embodiments.

FIG. 12 illustrates the propagation of area zone state information within a system, in accordance with example embodiments.

FIG. 14 illustrates examples of operations performed by a SAD that facilitate propagating state information, in accordance with example embodiments.

FIG. 15 illustrates operations performed by a SAD when communicating state information to a subscribing device, in accordance with example embodiments.

FIG. 16 illustrates operations performed by a SAD when receiving state information from devices and which facilitate determining whether to communicate earlier versions of state information to subscribing devices, in accordance with example embodiments.

FIG. 17 illustrates operations performed by a device when determining whether to perform state aggregation, in accordance with example embodiments.

FIG. 18 illustrates operations performed by a device when determining whether to perform state aggregation, in accordance with example embodiments.

FIG. 19A illustrates operations performed by a playback device when generating state information, in accordance with example embodiments.

FIG. 19B illustrates operations performed by a playback device when subscribing to state information, in accordance with example embodiments.

FIG. 20 illustrates operations performed by a particular primary playback device of a system comprising a plurality of playback devices, in accordance with example embodiments.

FIG. 21 illustrates operations performed by playback devices of a system, in accordance with example embodiments.

FIG. 22A shows a system that comprises devices that communicate information via a broker, in accordance with example embodiments.

FIG. 22B shows a system that comprises devices that communicate information via multiple brokers, in accordance with example embodiments.

FIG. 23A illustrates a system that includes various types of devices that communicate information via brokers, in accordance with example embodiments.

FIG. 23B illustrates a large system of devices that communicate information via brokers, in accordance with example embodiments.

FIG. 23C illustrates a device of a system communicating topics to multiple broker devices, in accordance with example embodiments.

FIG. 24 illustrates examples of topics and subscriptions communicated within a home theater system, in accordance with example embodiments.

FIG. 25 shows operations performed by a device when providing broker services, in accordance with example embodiments.

FIG. 26 shows operations performed by a publishing device that facilitate controlling when topics are communicated to subscribing devices, in accordance with example embodiments.

FIG. 27 shows operations performed by a publishing device that facilitate controlling whether past topic values are communicated to subscribing devices, in accordance with example embodiments.

FIG. 28 shows operations performed by a device when determining whether to provide or continue to provide broker services to other devices, in accordance with example embodiments.

FIG. 29 shows operations performed by a device when determining whether to provide or continue to provide broker services to other devices, in accordance with example embodiments.

FIG. 30A shows operations performed by a playback device when publishing topics, in accordance with example embodiments.

FIG. 30B shows operations performed by a playback device when subscribing to topics, in accordance with example embodiments.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Sharing of state information among devices facilitates coordinating activities of the devices. For example, a home automation system may comprise controllers, proximity sensors, temperature sensors, smart switches, cameras, etc. The sensors, switches, cameras, etc., may communicate state information to the controller to indicate, for example, the temperature in a particular room, whether an object entered the room, whether a light switch has been activated, etc.

Some existing playback systems include multiple audio playback devices that are networked communication with one another and are configured to share state information. For example, the playback devices of the system may share information that specifies playback device volume, playback device playback state, content information, etc. In some systems, state information that facilitates synchronous or groupwise playback of audio content among the devices is shared among the playback devices. To facilitate operating in groupwise fashion, each playback device may communicate relevant information to each other playback device via one or more communication channels. For example, the information may be communicated via one or more services that are similar to universal plug-and-play (UPnP) services. In this regard, each playback device may utilize a discovery protocol such as one that is similar to simple service discovery protocol (SSDP) that defines procedures for advertising services provided by the playback device and for discovering the services provided by other playback devices.

For example, in some existing systems, each playback device implements a device properties (DP) service and a group management (GM) service and subscribes to the DP service and GM service of every other playback device. Through each of these services, the playback device may receive commands from other devices or generate events that can be subscribed to by other devices. For example, the playback device may, via the GM service, receive one or more commands for controlling the playback device to join a group, leave a group, etc. The playback device may, via the DP service, receive one or more commands to change the state of a status LED of the playback device (e.g., on/off/dimmable state, etc.), create a bonded zone with other devices, etc. When the state of the playback device changes, that playback device may, via the DP service, generate an event to notify subscribing devices of the change in state. For example, if the name of a playback device changes to “Living Room,” the playback device may communicate an event indicative of the change to a controller that has subscribed to the DP service for receiving such an event. The controller can then responsively update its user interface to convey this information.

A zone group topology (ZGT) service of each playback device may determine the network topology associated with a particular group or zone of playback devices based on information provided via the DP and GM services. Devices, such as controllers, can subscribe to the ZGT service of any playback device to quickly identify the playback devices and audio groups that are present within a particular household. The controllers can also subscribe to the audio visual transport (AVT) service of group controllers to acquire, for example, transport control information about the content currently playing in particular rooms associated with respective group controllers, such as whether the content is currently playing, is paused, the next track to be played, etc.

This manner of communicating information between playback devices works well in some existing systems, such as in existing systems where the number of playback devices is relatively small. However, this manner of communicating information does not scale well to a relatively large number of devices in at least some circumstances and in at least some certain respects because the number of messages that must be exchanged device-to-device to facilitate these communications generally increases exponentially with the number of devices in the system. In practical terms, this limits the number of playback devices that can operate effectively within a network of playback devices to about ten playback devices.

Various examples of systems, devices, and methods disclosed herein facilitate efficiently communicating information among devices operating in a networked environment. For example, when the techniques described herein are used by playback devices of a media content playback system, the techniques facilitate reducing the amount of information required to be communicated between the playback device to coordinate the playback of audio content. The reduced network traffic facilitates increasing the number of devices that can effectively communicate within the network (e.g., to facilitate operating hundreds of devices, or more, as part of the same network of devices, including systems of playback devices). In particular, these communication techniques do not require the use of existing services such as those similar to UPP services and exponentially increasing message exchange, which is characteristic of some existing communication techniques. Some examples of the device correspond to playback devices, control devices, network devices, etc., that operate within a network of devices that include playback devices and/or groups of such playback devices. Some of these playback devices are configured to play audio content streamed from one or more other devices of the group and can be configured to play the audio content in synchrony.

### A. Information Sharing Using Global State Aggregators

Some examples of the devices communicate information to one another via a global state aggregation device (sometimes referred to simply as a “GSAD”). For example, each device of a plurality of devices may generate state information that specifies the state of various aspects of the device at any moment. One or more GSADs may subscribe to these devices to receive aspects of the state information from these devices. A plurality of subscribing devices may subscribe to the GSADs for particular aspects of the state information. The GSADs forward to the subscribing devices subscribed to state information received from the other devices and that matches the subscription.

Some examples of systems disclosed herein comprise one or more primary playback devices (PPDs) that are grouped with one or more secondary playback devices (SPDs) to provide one or more audio playback zones. In some examples, the PPDs perform the aggregating operations described above (e.g., they perform the operations of a GSAD) with respect to their corresponding SPDs. In examples of these systems, each PPD subscribes to the state information generated by the SPDs of the corresponding group. Each PPD of the system also subscribes to each other PPD of the system.

Some examples of systems disclosed herein comprise one or more primary playback devices (PPDs) that are grouped with one or more secondary playback devices (SPDs) to provide one or more audio playback zones, and also one or more GSADs. (Note: some examples of GSADs may perform the operations described herein attributed to PPDs.) The PPDs perform aggregating operations described above with respect to their corresponding SPDs. In some examples, each GSAD subscribes to every PPD of the system and to every other GSAD of the system. That is, each PPD communicates state information to every GSAD. However, in some of these examples, the PPDs do not directly communicate state information to one another.

In some examples, each GSAD subscribes to one or more particular PPDs of the system and to every other GSAD of the system. That is, each PPD communicates state information to a subset of the GSADs.

Some examples of the devices are configured to perform one or more of the communication techniques described in the applications incorporated by reference above titled “Broker/Subscriber Model for Information Sharing and Management Among Connected Devices,” “Multiple Broker Deployment for Information Sharing and Management Among Connected Devices,” “Multichannel Content Distribution,” “Playback System Architecture,” “Playback Systems with Dynamic Forward Error Correction,” and “Multiple Broker Deployment for Information Sharing and Management Among Connected Devices.”

Some examples of devices store state information using a hierarchically structured syntax such as JSON, XML, etc. Some examples of subscriptions that are used to obtain state information stored by these devices are specified using a multilevel syntax that facilitates querying/obtaining one or more aspects of the state information. Some examples of the subscription may include one or more wildcards.

Some examples of the systems comprise numerous devices capable of performing state aggregation operations. In some examples, a rank is determined for each device of the system that performs (or can be configured to perform) state aggregation operations. In some examples, if a particular device determines that its corresponding rank is lower than the rank of another device, the particular device may defer to the other devices for performing state aggregation operations. For example, the lower-ranked device may refuse to advertise that it is available to perform state aggregation operations.

In some examples, the rank of the device is determined based on the role the device plays within the network of devices. For example, a group of playback devices configured to operate in synchrony as part of a home theater system may each be capable of performing state aggregation operations. The center channel playback device may be configured to receive a stream of audio content from an audio content source and to distribute appropriate audio content to the playback devices of the group. Given its role, the center channel playback device may rank higher than the other playback devices and, therefore, be used to perform state aggregation operations among the playback devices. In another example, a non-portable playback device is ranked higher than a portable playback device because the non-portable playback device may have a more reliable source of power or because the location of the playback device is relatively static. In another example, playback devices having wired network connections may be ranked higher than playback devices having a wireless network connection because the wired network connections may have better network characteristics (e.g., more reliable, lower latency, higher bitrate, etc.)

In some examples, a propagation policy is associated with a category of state information and indicates when the state information should be propagated to other devices. An example of the propagation policy indicates to a device that the corresponding state information should be communicated to a subscribing device a nominal amount of time after the state information has been generated by the device and/or received from another device. For example, the device may add the state information to a state information delivery queue of the device and immediately communicate the state information to subscribing devices or may communicate the state information to subscribing devices shortly after state information that precedes the newer state information in the queue has been communicated to subscribing devices. Another example of the propagation policy indicates to the device that the state information should be communicated by the device to subscribing devices after a particular interval of time (e.g., after 5 seconds, at a particular scheduled time, etc.).

In some examples, a retention policy that indicates whether earlier versions of a particular category of state information or a particular number of earlier versions of the state information should be maintained. In this case, the device is configured to retain corresponding past versions of the state information and to communicate these versions to subscribing devices. For example, now-playing state information may be subject to a retention policy that indicates that past versions of the state information should be retained indefinitely or until further notice. For instance, the now-playing state information of a playback device may indicate at a first time that the currently playing track as “/Device/P1/Props/NowPlaying=XYZ” and at a later time as “/Device/P1/Props/NowPlaying=ABC.” As such, the device may communicate both “/Device/P1/Props/NowPlaying=XYZ” and “/Device/P1/Props/NowPlaying=ABC” to a subscribing device that subscribes to “/Device/P1/Props/NowPlaying.”

### B. Information Sharing Using Brokers

Some examples of the devices communicate information to one another via a broker device (sometimes referred to simply as a “broker”). For example, a plurality of publishing devices may publish information or topics that specify publishing device properties or attributes to a broker. A plurality of subscribing devices may subscribe to the broker for particular topics. The broker forwards topics published by publishing devices to subscribing devices that have subscribed to the topics.

Some examples of the devices are configured to perform one or more of the communication techniques described in the applications incorporated by reference above titled “Multichannel Content Distribution,” “Playback System Architecture,” “Playback Systems with Dynamic Forward Error Correction,” and “Multiple Broker Deployment for Information Sharing and Management Among Connected Devices.”

Some examples of the devices are configured to perform communication techniques that are similar in some respects to messaging queuing technology transport (MQTT) standards promulgated under, for example, OASIS Open standards body (e.g., MQTT V1.0 or newer). The documents that describe these standards are incorporated herein by reference in their entirety. In this regard, some examples of publishing devices, broker devices, and subscribing devices disclosed herein are configured to use various messages to communicate topics and subscriptions. Some examples of topics have a multi-level syntax, such as “/Device/P1/Core/ModelNo=12345”. This topic specifies the value for the model number for a particular device having the identifier P1. The model number is a core property of the device. A subscription such as “/Device/+/Core/ModelNo” (“+” being a wildcard) causes the broker to communicate the model number (more specifically, the topic that specifies the model number) for any devices that publish the model number using the same topic syntax. In another example, a subscription such as “/Device/P1/Core/#” (“#” being a wildcard) causes the broker to communicate all the core properties of device P1 to subscribing devices.

In some examples, different quality of service (QoS) delivery guarantees can be associated with data published to topics: In these examples, a publishing device may communicate topics along with a QoS level for the topic. For QoS level 0 topics, the publishing device simply publishes the message to the broker without receiving an acknowledgement from the broker. For QoS level 1 topics, the broker communicates an acknowledgement back to the publishing device. The publishing device will re-send the topic until it receives the acknowledgement. For QoS level 2 topics, additional messages are communicated between the publishing device and the broker to confirm the topic has been sent and that the acknowledgement has been received.

Some examples of the devices are configured to operate as a publisher, subscriber, and/or a broker. When operating as a publisher, the device is configured to communicate topics to a broker. The topic specifies properties of the device and can comprise a topic name and a topic value (e.g., “/Device/P1/Core/ModelNo=12345”). When operating as a broker, the device is configured to receive topic data from a publishing device and to receive subscription data that specifies at least one topic filter (e.g., “/Device/P1/Core/ModelNo”) from a subscribing device. The device is configured to determine whether the topic filter matches the topic data, and after determining that the topic filter matches the topic data, communicate the topic data to the subscribing device. When operating as a subscriber, the device is configured to communicate subscription data that specifies at least one topic filter to a broker of another device and to receive, from the broker, topic data that matches the subscription data.

Some examples of the devices are configured to simultaneously operate as a publisher, subscriber, and broker. In some of these examples, the publisher of the device publishes topics to the broker of the device (i.e., the device in its role as a publisher “publishes” topics to itself in its role as a broker). Similarly, the broker of the device can forward matching topics to the subscriber of the device.

Some examples of the systems comprise numerous devices that offer broker services. In some examples, a broker rank is determined for each device of the system that offers (or can be configured to offer) broker services. In some examples, if a particular device determines that its corresponding rank is lower than the rank of another broker, the device may defer to the other broker for offering broker services. For example, the lower-ranked device may refuse to advertise broker services.

In some examples, the rank of the broker is determined based on the role the broker plays within the network of devices. For example, a group of playback devices configured to operate in synchrony as part of a home theater system may each be capable of implementing a broker. The center channel playback device may be configured to receive a stream of audio content from an audio source and to distribute appropriate audio content to the playback devices of the group. Given its centralized role, the broker of the center channel playback device may rank higher than the brokers of the other playback devices and, therefore, be used to broker information (e.g., state information) among the playback devices. In another example, a broker of a non-portable playback device is ranked higher than a broker of a portable playback device because the non-portable playback device may have a more reliable source of power or because the location of the playback device is relatively static. In another example, playback devices having wired network connections may be ranked higher than playback devices having a wireless network connection because the wired network connections may have better network characteristics (e.g., more reliable, lower latency, higher bitrate, etc.)

In some examples, a propagation policy that indicates when a topic should be published can be specified or associated with a topic. An example of the propagation policy indicates to the broker that the corresponding topic should be communicated to a corresponding subscribing device a nominal amount of time after the topic data has been received. For example, the broker adds the topic to a topic delivery queue of the broker and immediately communicates the topic to subscribing devices or communicates the topic to subscribing devices shortly after other topics that precede the topic in the queue have been communicated to subscribing devices. Another example of the propagation policy indicates to the broker that the topic should be communicated by the broker to corresponding subscribing devices after a particular interval of time (e.g., after 5 seconds, at a particular scheduled time, etc.). In some examples, the publishing device specifies the propagation category and communicates the propagation category to the broker in the same message that specifies the topic.

Some examples of the broker only communicate topics to subscribing devices after corresponding subscriptions are received from the subscribing devices. That is, the topic is not retained by the broker. However, a publishing device can specify a retain flag along with the topic that causes the broker to retain the topic so that the topic can be communicated to subscribing devices after corresponding subscriptions are received. However, only the most recent topic is retained and communicated. The past values for the particular topic are not maintained. For example, in one example implementation, if a publishing device communicates a topic that specifies the volume level of the device and publishes this topic each time the volume level changes, only the most recent version of the topic (i.e., the topic that specifies the most recent volume level) is retained.

Some examples of the device can specify a retention policy with a topic that indicates whether past values of a topic should be maintained. An example of the retention policy indicates to the broker that past values for the corresponding topic should be maintained and communicated to a corresponding subscribing device. For example, a publishing device may specify a retention policy that indicates that past values or the last N values associated with a particular topic should be maintained. The broker is configured to retain the corresponding past values of the topic and to communicate these values to subscribing devices. For example, a playback device may at a first time publish the topic “/Device/P1/Props/NowPlaying=XYZ” and at a second time publish the topic “/Device/P1/Props/NowPlaying=ABC.” The playback device may specify to the broker that these topics should be retained indefinitely or until further notice. As such, the broker may communicate both “/Device/P1/Props/NowPlaying=XYZ” and “/Device/P1/Props/NowPlaying-ABC” to a subscribing device that subscribes to “/Device/P1/Props/NowPlaying.” In some examples, the broker concatenates the past values (e.g., into an array) into a single forwarded topic such as “/Device/P1/Props/NowPlaying={XYZ, ABC}.”

As noted above, some examples of the devices are configured to operate as a networked group of devices with hundreds of other devices in a system. To facilitate scaling to arbitrarily large groups, some examples of the system comprise multiple brokers. In this regard, some examples of the device publish topics to particular brokers of the system and subscribe to particular brokers of the system. The published to and subscribed to brokers can be different. In this regard, some examples of the device are configured to determine the number of other devices operating in a networked system and to determine the required number of brokers that should be implemented amongst the devices to facilitate communications between the devices. After determining that the number of required brokers is less than the number of implemented/operating brokers, the device is configured to perform broker operations. The number of required brokers may be proportional to the number of devices operating in the system that need to communicate information to one another.

Some examples of the device are configured to communicate topics to a plurality of brokers. For example, a playback device may be configured to communicate a topic that specifies now playing content to several brokers. The playback device may, in turn, subscribe to topics forwarded by a particular broker.

As indicated, the operations performed by broker, publisher, and subscriber devices may be analogous to those performed by GSADs, PPDs, and SSDs. For example, a GSAD may be an example of a broker or a broker may be an example of a GSAD. As such, the aspects disclosed above that relate to broker, publisher, and subscriber devices can be applied to GSADs, PPDs, and SPDs and the aspects disclosed above that relate to GSADs, PPDs, and SSDs can be applied to broker, publisher, and subscriber devices.

The above-described embodiments, as well as additional and alternative embodiments, are described in more detail herein. While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

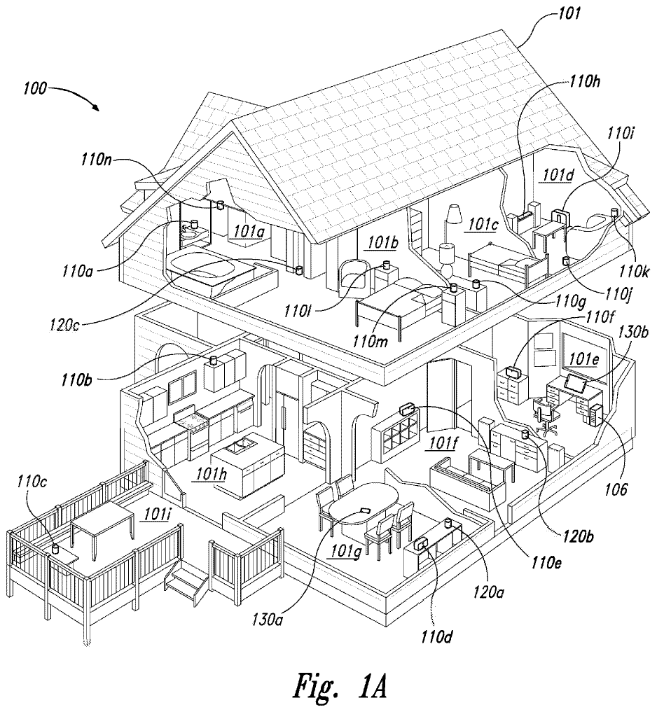

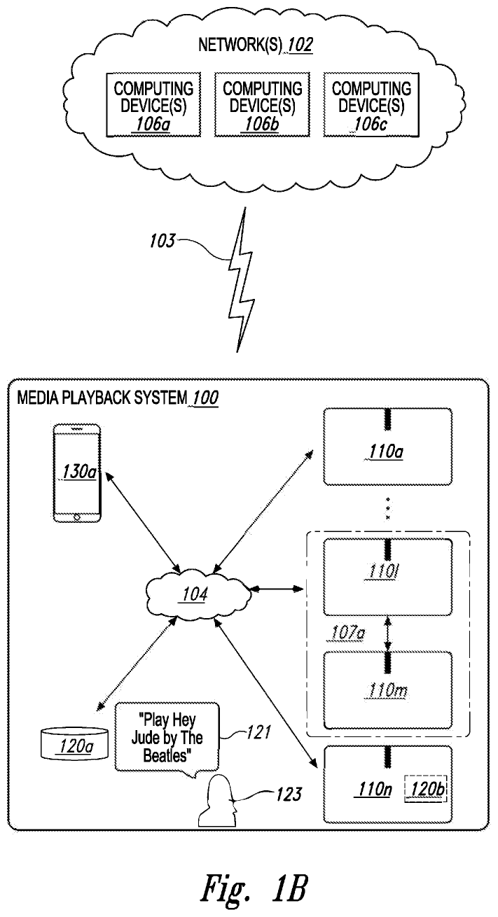

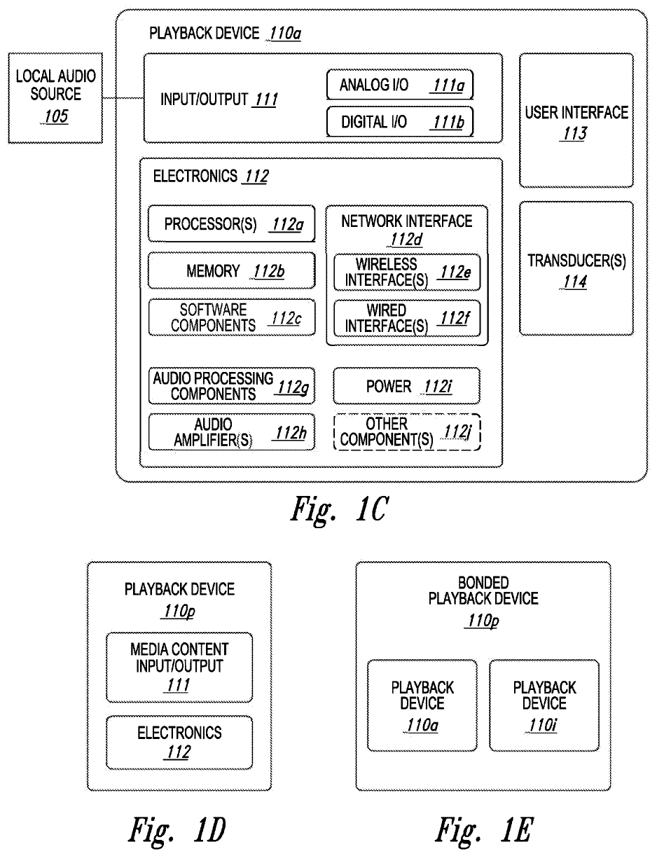

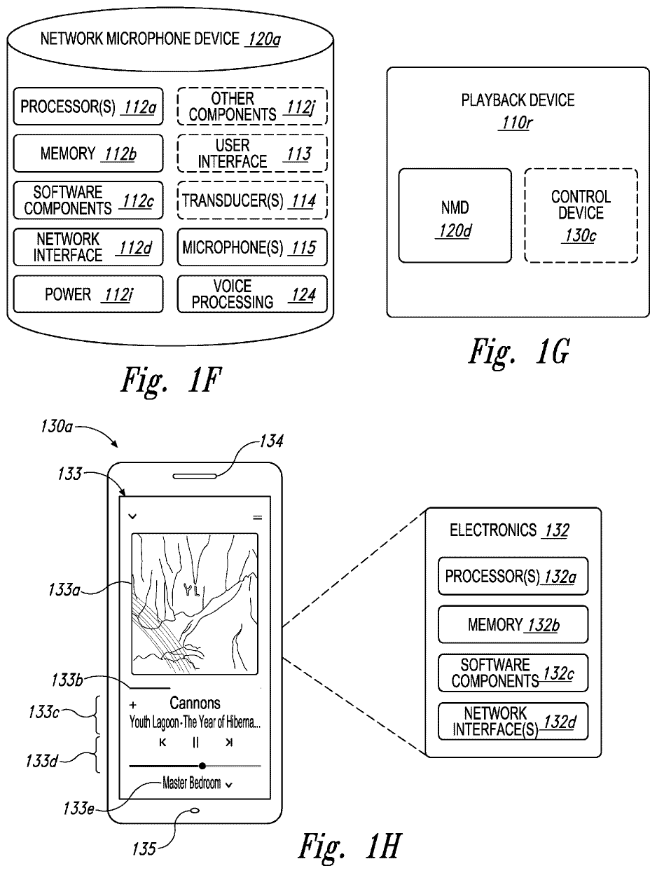

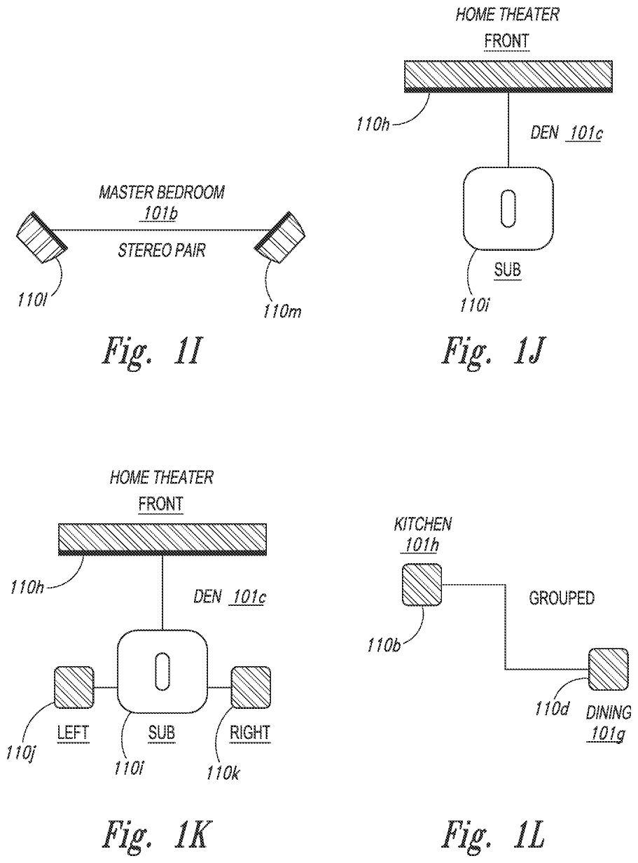

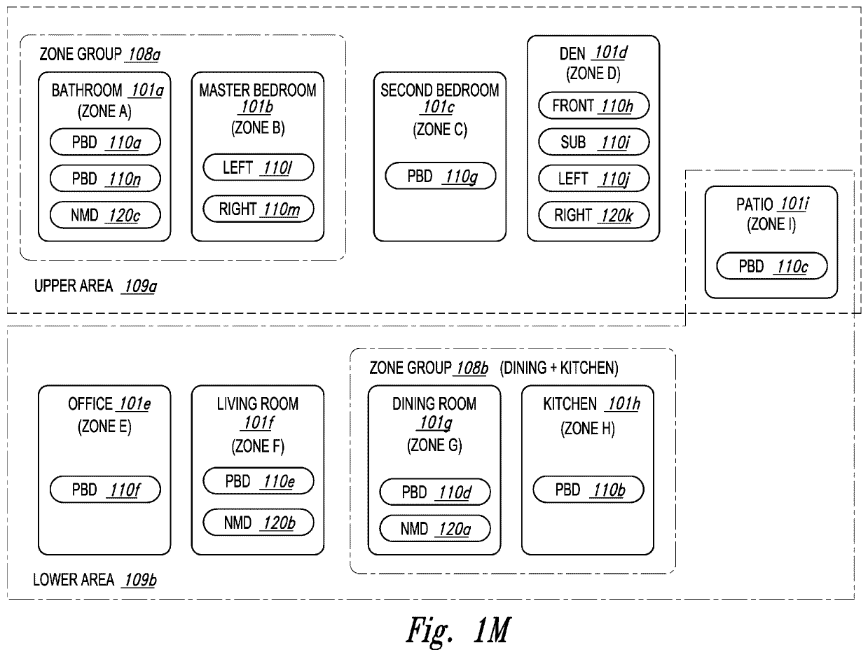

In the Figures, identical reference numbers identify generally similar and/or identical elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1L.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to, for example, FIGS. 1B and 1E and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

### C. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communications links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communications links.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1-I through IM.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

### D. Suitable Playback Devices

FIG. 1C is a block diagram of the playback device 110a comprising an input/output 111. The input/output 111 can include an analog I/O 111a (e.g., one or more wires, cables, and/or other suitable communications links configured to carry analog signals) and/or a digital I/O 111b (e.g., one or more wires, cables, or other suitable communications links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises an High-Definition Multimedia Interface (HDMI) interface and/or cable. In some embodiments, the digital I/O 111b includes one or more wireless communications links comprising, for example, a radio frequency (RF), infrared, WiFi, Bluetooth, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communications link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some embodiments, the operations further include causing the playback device 110a to send audio information to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

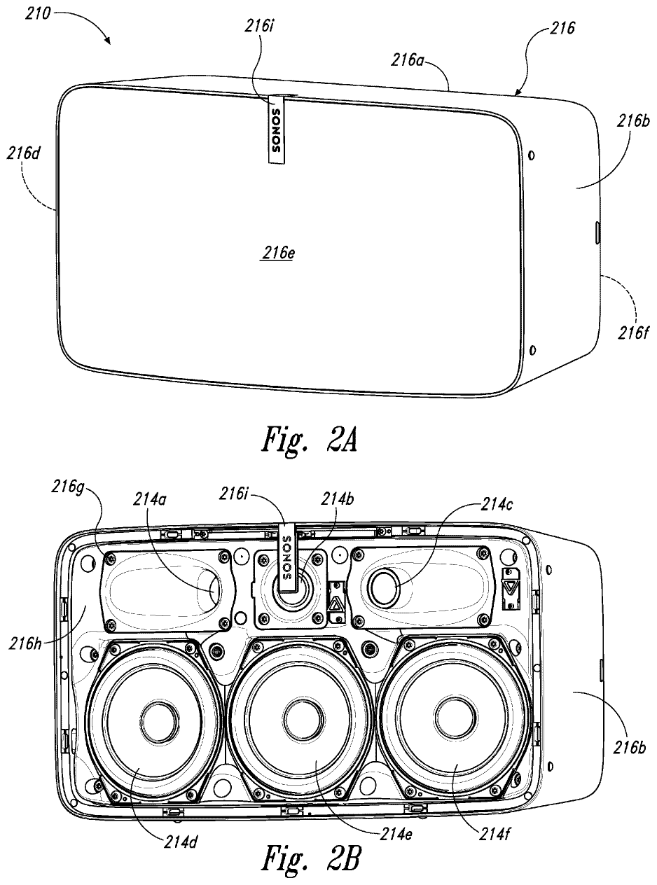

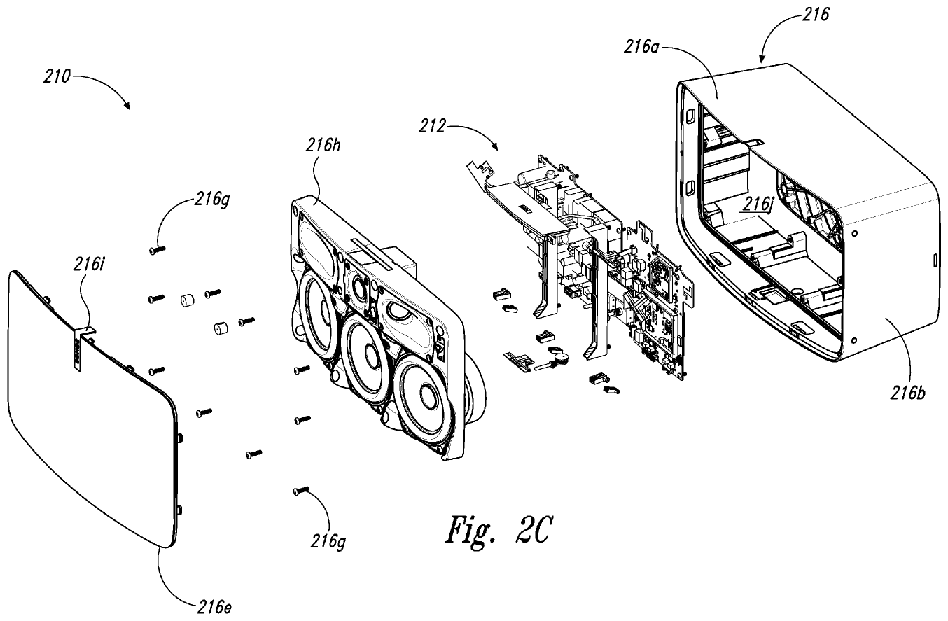

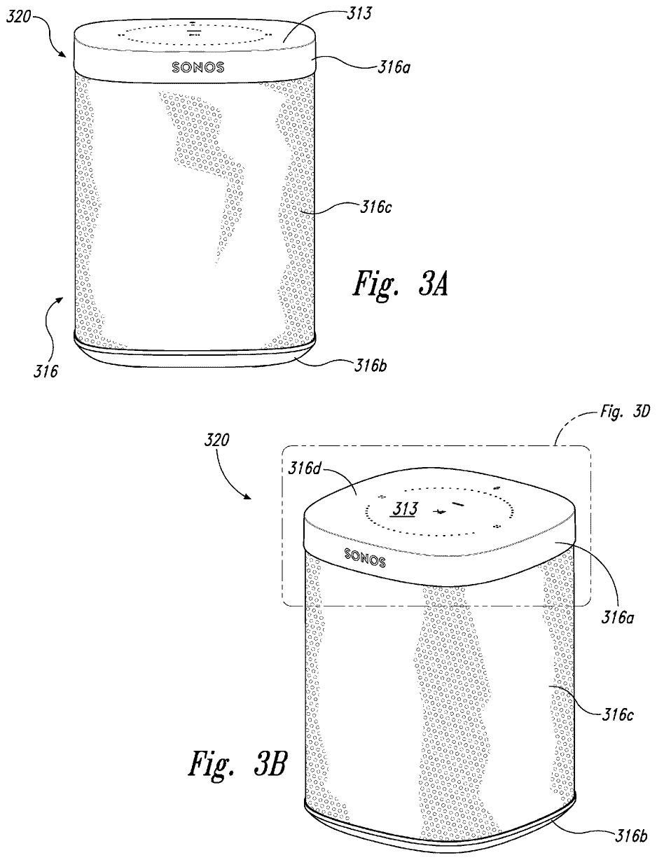

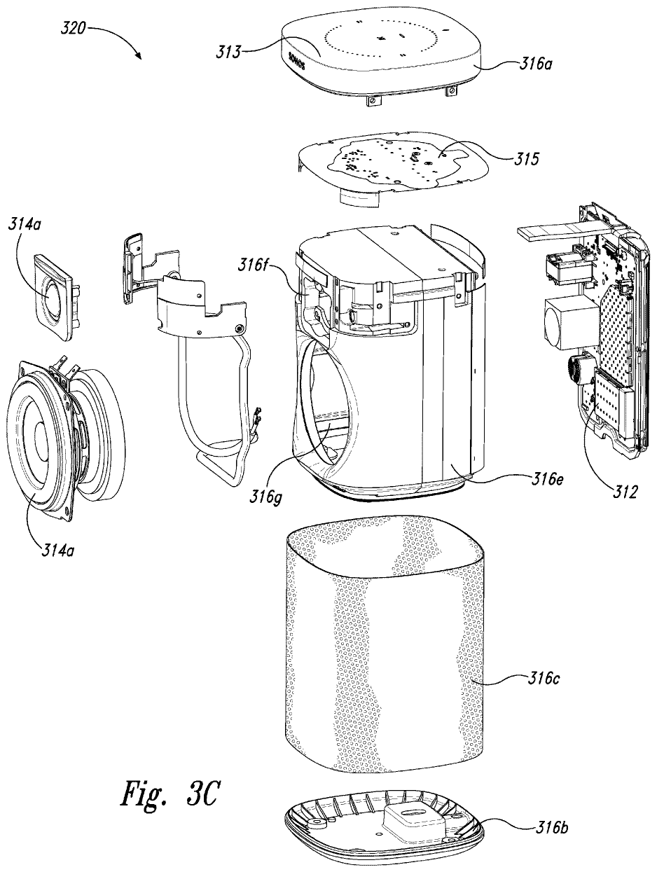

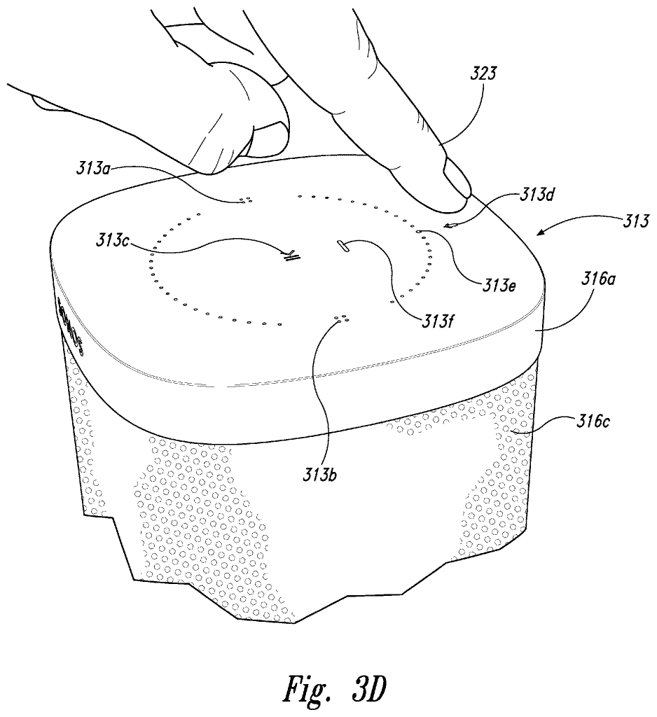

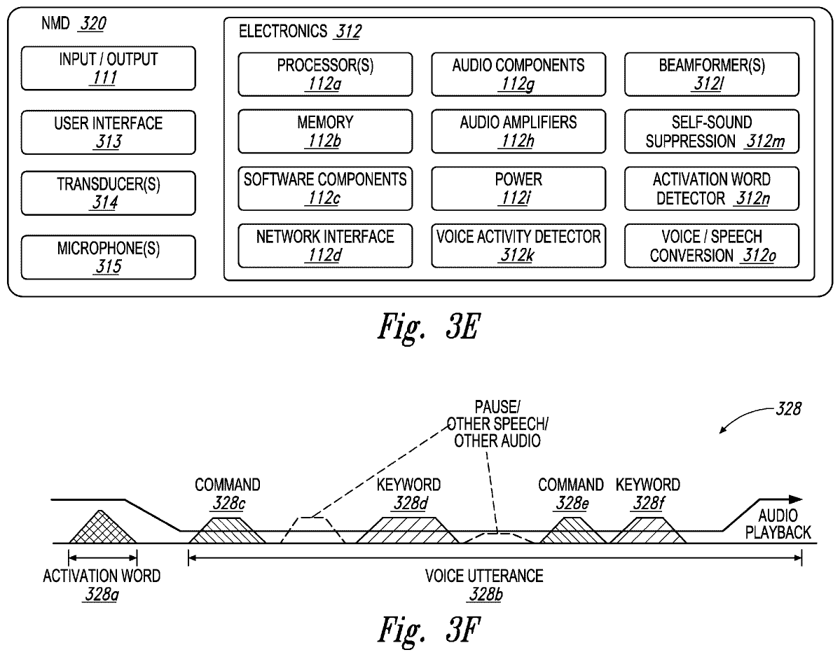

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

### E. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

### F. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others. Additional description of zones and groups can be found below with respect to FIGS. 1-I through 1M.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

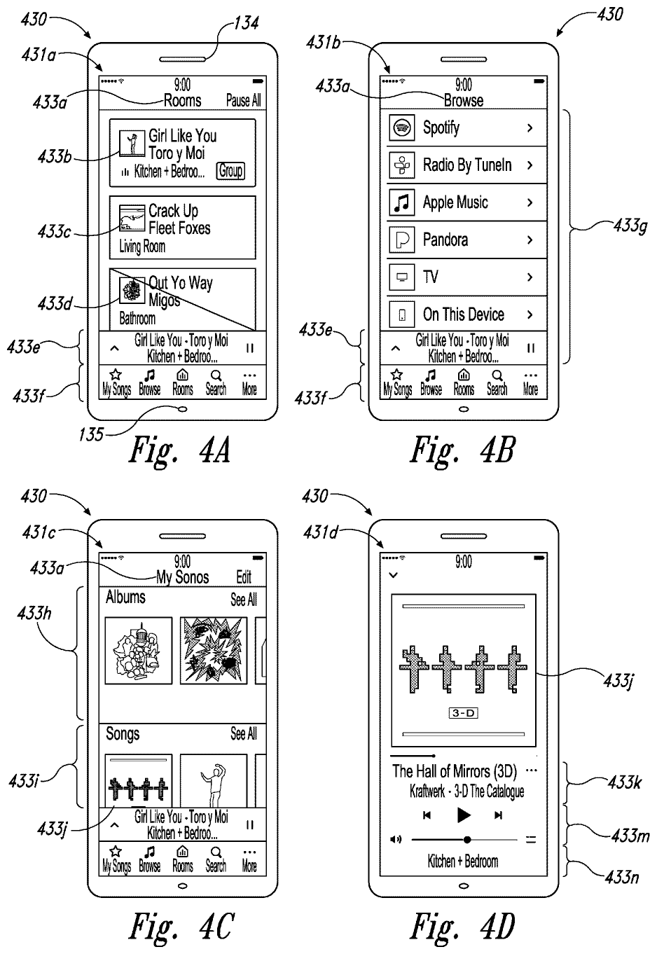

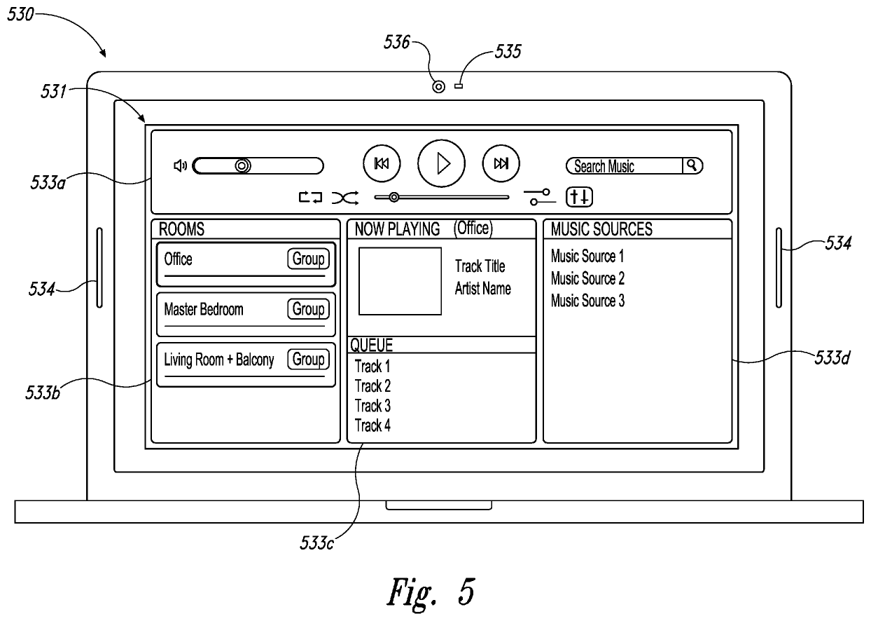

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device embodiments are described in further detail below with respect to FIGS. 4A-4D and 5.

### G. Suitable Playback Device Configurations

FIGS. 1-1 through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110l (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can have be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some embodiments, however, the playback device 210 omits the filter 216i. In other embodiments, the playback device 210 includes one or more additional filters aligned with the transducers 214b and/or at least another of the transducers 214.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 316 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio information corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 3120 (e.g., voice-to-text and text-to-voice). In the illustrated embodiment of FIG. 3E, the foregoing components 312k-3120 are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise.

The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g. AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 3120 may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include a activation word portion 328a and a voice utterance portion 328b. In some embodiments, the activation word 557a can be a known activation word, such as “Alexa,” which is associated with AMAZON's ALEXA®. In other embodiments, however, the voice input 328 may not include a activation word. In some embodiments, a network microphone device may output an audible and/or visible response upon detection of the activation word portion 328a. In addition or alternately, an NMB may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

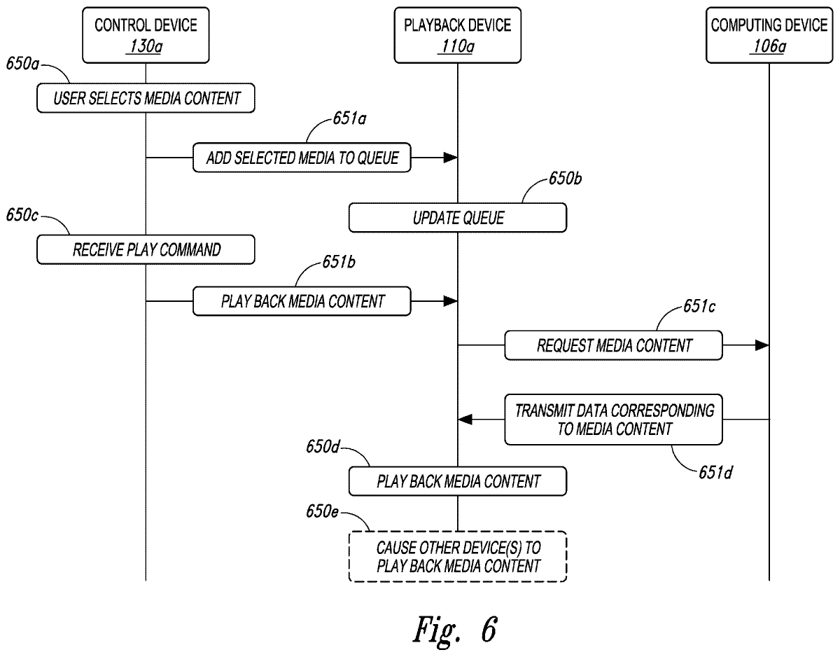

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the first computing device 106a requesting the selected media content. The first computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the first computing device 106a, and begin playback of the selected media content in response to a message from the playback device 110a such that all of the devices in the group play back the selected media content in synchrony.

### IV. Information Sharing Among Devices

As noted above, some existing playback systems comprise a plurality of playback devices, and each playback device may establish one or more communication links with each other playback devices to interact with the services of the other playback devices. For example, some playback devices of conventional playback systems may implement a device properties (DP) service and a group management (GM) service and subscribe to the DP service and GM service of every other playback device 110. A zone group topology (ZGT) service of each playback device 110 may be used to determine the topology of a particular group or zone of playback devices 110 based on this information, and control devices 130 can subscribe to the ZGT service of any playback device to quickly identify the playback devices 110 and audio groups that are present within a particular household. However, this manner of communicating information does not scale well because the number of communication links grows exponentially with the number of playback devices. In practical terms, this limits the number of playback devices 110 that can operate effectively in such a topology.

These and other issues are ameliorated by various example systems described herein. In some examples, state information associated with various devices, and that represents the state of the system at any moment in time, is propagated between devices using a broker/publisher/subscription methodology. In these examples, one or more devices of the system publish state information and/or subscribe to receiving state information. In some examples, broker devices serve as intermediary devices that facilitate the flow of state information between publishing devices and subscribing devices. In some examples, particular devices referred to herein as global state aggregating devices (GSADs) are used to aggregate and propagate the state information between primary playback devices (PPDs) and secondary playback devices (SPDs).

As indicated, the operations performed by broker, publisher, and subscriber devices may be analogous to those performed by GSADs, PPDs, and SSDs. For example, a GSAD may be an example of a broker or a broker may be an example of a GSAD. As such, the aspects disclosed below that relate to broker, publisher, and subscriber devices can be applied to GSADs, PPDs, and SPDs and the aspects disclosed below that relate to GSADs, PPDs, and SSDs can be applied to broker, publisher, and subscriber devices.

Using the example devices described above to perform the aggregating and propagation of the state information reduces the overall number of communication links that need to be established between devices of the system to facilitate operation of the system. This, in turn, reduces network congestion and can reduce the processing and storage requirements of those devices that are no longer required to maintain the state of all the devices of the system.

### A. Using One or More GSADs to Share Information

### 1. State Information and Subscriptions

Some example devices described herein propagate the aforementioned state information to one another using a technique that involves a first device receiving, from a second device, a subscription for state information, and the first device communicating the subscribed to state information to the second device. In general, after the first device receives the subscription from the second device, the first device communicates the subscribed to state information. As described in later sections, the state information may be communicated only once (e.g., after the subscription is received), periodically (e.g., every 10 seconds), whenever the state information is updated, etc.

Some examples of the state information of a device are represented within the device using a hierarchically structured syntax such as JSON, XML, etc. For instance, a particular playback device of a playback zone may store state information such as:

```
{
  “playerId”: “RINCON_5CAAFD0518DE01400”,
  “chanMap”: “LF,LF”,
  “name”: “StudioLeft”,
  “volumeBtn”: “zone”,
  “isPrimary”: “false”
}
```

This state information indicates, for example, the identifier of the playback device, the channel (e.g., left channel) to which the playback device is assigned, and whether the playback device is a primary device (which, in this case, is false). Primary playback devices are described in more detail below. Generally, however, some examples of primary playback devices coordinate the playback of audio content among groups of playback devices. An example of such a primary playback device that is part of a group that includes the playback device described above may include state information such as:

```
{
    “name”: “Playback zone A”,
    “players”: [
      {
        “playerId”: “RINCON_5CAAFD0518DE01400”,
        “chanMap”: “LF,LF”,
        “name”: “StudioLeft”,
        “volumeBtn”: “zone”,
        “isPrimary”: “true”
      },
      {
        “playerId”: “RINCON_B8E937B7900601400”,
        “chanMap”: “RF,RF”,
        “name”: “StudioRight”,
        “volumeBtn”: “local”
        “isPrimary”: “true”
      }
  ]
}
```

This state information indicates the name of the playback zone (e.g., Playback zone A) and provides a list of playback devices that belong to the playback zone along with the state information of each playback device. That is, the primary playback device aggregates the state information of the playback devices that belong to the playback zone. In this example, the key “isPrimary” of the second “players” entry has a value of true which indicates the corresponding playback device is the primary playback device of the group.

Some examples of subscriptions that are used to obtain state information stored by a device are specified using a multilevel syntax that facilitates querying/obtaining one or more aspects of the state information. Some examples of the subscription may include one or more wildcards. For example, communicating a subscription such as “/players/playerId/RINCON+” (“+” being a wildcard) to the primary playback device above from a second device may cause the primary playback device to communicate the following state information to the second device:

```
{
    “players”: [
      {
        “playerId”: “RINCON_5CAAFD0518DE01400”,
      },
      {
        “playerId”: “RINCON_B8E937B7900601400”,
      }
  ]
}
```

As indicated, the state information communicated to the second device is only a subset of the state information stored within the primary playback device.

### 2. Primary Playback Devices Subscribe to all Other Primary Devices

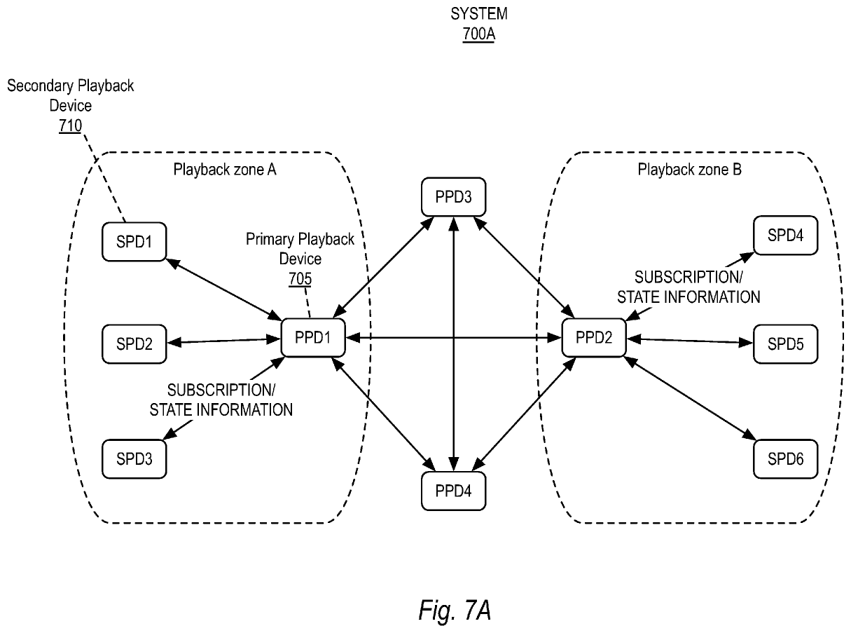

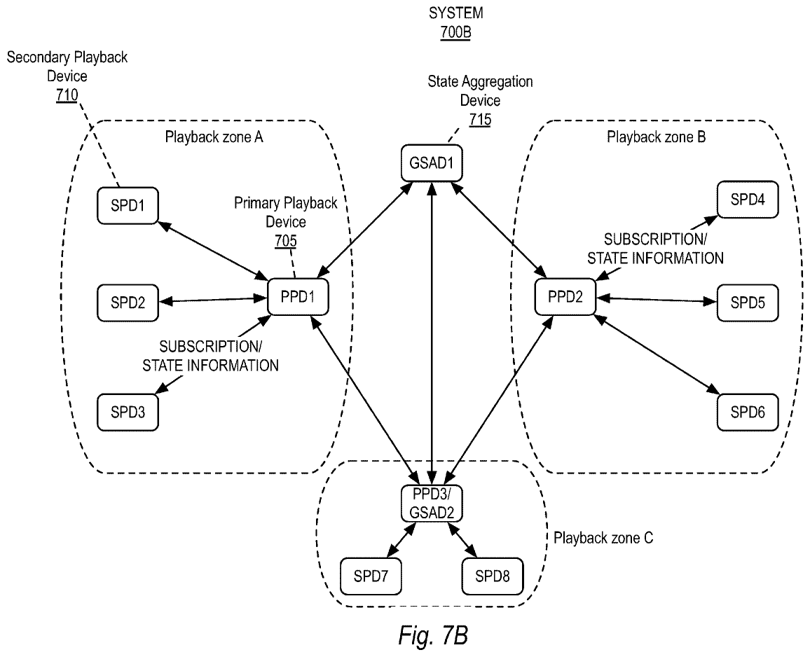

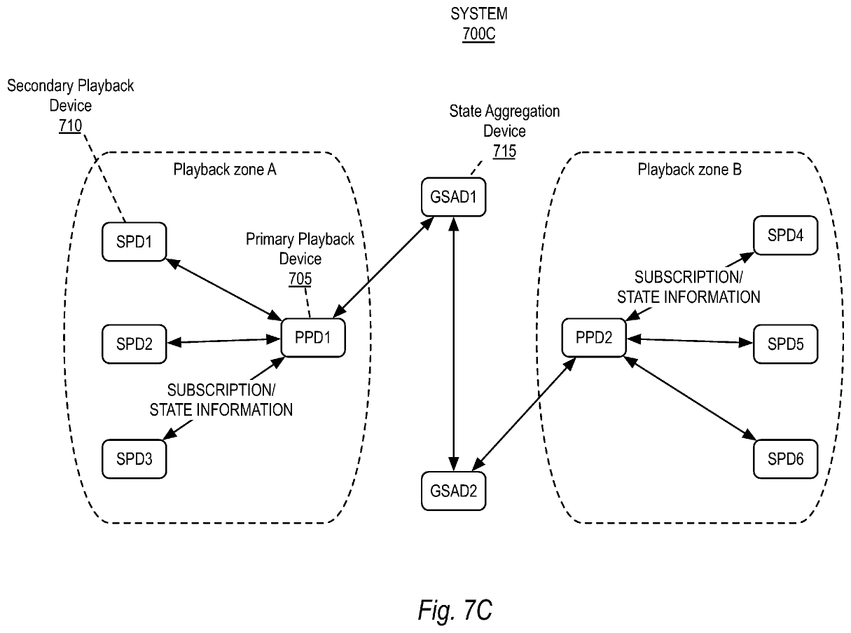

FIG. 7A illustrates an example system 700A in which particular playback devices referred to herein as primary playback devices 705 (PPDs) aggregate and propagate state information among the playback devices of the system 700A. That is, each PPD 705 performs the state aggregation operations of a GSAD (e.g., is a GSAD implementing PPD). This is different from some other example embodiments described herein in which not all PPDs (and perhaps not any) PPDs are GSAD implementing PPDs.

In the figure, non-aggregating devices are referred to simply as secondary playback devices 710 (SPDs). The SPDs 710 are associated/grouped with particular PPDs 705 and communicate various aspects of their respective state information to one another and to other devices via associated PPDs 705. For instance, PPD1 and SPD1-SPD3 form a first zone group (e.g., Playback zone A), and PPD2 and SPD4-SPD6 form a second zone group (e.g., Playback zone B). PPD2 and PPD4 may be standalone playback devices (i.e., each corresponding to a single-device zone group).

In the configuration of FIG. 7A, each PPD 705 subscribes to receiving state information from each SPD 710 of an associated group according to the techniques described above. Each PPD 705 may subscribe to all categories of state information available from SPDs 710 of the group or to a subset of state information that is relevant to the operation of the system 700A. For example, PPD1 may subscribe to SPD1-SPD3 to receive all categories of state information stored in SPD1-SPD3 and PPD2 may subscribe to SPD4-SPD6 to receive all categories of state information stored in SPD4-SPD6. In a similar manner, SPD1-SPD3 may subscribe to one or more categories of state information stored in PPD1 and SPD4-SPD6 may subscribe to one or more categories of state information stored in PPD2. PPD1-PPD2 may subscribe to all categories of state information stored in one another so that each PPD 705 has a complete picture of the state information of all the devices of the system 700A at any moment, as provided directly by each other PPD.

In some examples, the SPDs 710 and the PPDs 705 may be the same or similar type of device. For example, each device may be one playback device of a 5.1 channel surround sound system, one of the playback devices of a left/right channel pair, or simply one playback device of a group of playback devices arranged throughout a dwelling. As indicated above, the group of playback devices may define an audio playback zone (e.g., playback zone A) in which audio content is played among the playback devices in synchrony. As noted previously, the PPD 705 may correspond to the playback device of the group that coordinates the operations of the group (e.g., the group coordinator). For example, the PPD 705 may receive audio content from an audio content source (e.g., a streaming audio service) and coordinate the playback of audio content received from the audio content source among the respective devices of the group. In some examples, this involves communicating the audio content or portions of the audio content to the other devices of the group (e.g., the SPDs 710) along with timing information that facilitates the playback of audio content in synchrony.

As another example, each device may be one playback device of an area zone. Such a zone can correspond to a large venue (e.g., a department store, auditorium, etc.) and can include a virtually unlimited number of playback devices that play audio content in synchrony. The playback devices may correspond to different types of playback devices (e.g., different models, sizes, audio characteristics, power ratings, etc.) Additional examples of such zones are described in U.S. Provisional App. 63/502,347, filed May 15, 2023, and titled “Area Zones” and U.S. Provisional App. 63/377,948, filed Sep. 30, 2022, and titled “Playback System Architecture.” The content of these applications is incorporated herein by reference in its entirety.

The designation of one of the devices as the PPD of the group may depend on a variety of factors. For instance, in an example 5.1 surround sound configuration, the center channel playback device may be the PPD. In some examples, the determination of whether a particular playback device should be assigned the role of the PPD 705 depends on the type of network connection the playback device has to the underlining network of the system. For example, a playback device that is wired to the network and wirelessly connected to other playback devices may be assigned the role of the PPD due to the inherent performance benefits of the wired connection (as opposed to a wireless connection). Other reasons why a particular device may be assigned the role of the PPD and the manner by which a particular device may be assigned the role are described in later sections.

An illustrative example of the operation of the system 700A of FIG. 7A involves aggregating and propagating basic state information among the devices of the group. (The particulars of basic state information are described in a later section below). This operation may involve each PPD 705 subscribing to its SPDs 710 to receive the basic state information of its SPDs. Because each PPD 705 is a GSAD implementing PPD, it subscribes to each other PPD 705 to aggregate the basic state information of all the devices of the system 700A. And each SPD 710 subscribes to its PPD 705 to receive state information. After these operations are complete, each device of the system will have the basic state information of each device of the system 700A.

In some examples, devices that are not characterized by the subscribed to state information may not respond to the subscription. Further, in some examples, devices do not attempt to subscribe to devices that are known to not be characterized by the sought-after state information.

Further, in some examples, PPDs and SPDs do NOT attempt to propagate state information to those devices from which particular state information originated. This, in turn, mitigates the chances of creating infinite loops of state information transfer between devices. For example, state information may be communicated from PPD1 to PPD3 and then from PPD3 to PPD2. In this case, PPD2 may not communicate the state information back to PPD1 or PPD3, which could otherwise cause an infinite loop of state information transfers. The manner by which this aspect is enforced is described in more detail in a later section.

### 3. All Aggregating Devices Subscribe to all Primary Devices

FIG. 7B illustrates an example system 700B in which GSADs 715, which in some examples (e.g., PPD3/GSAD2) correspond to GSAD implementing PPDs, are primarily responsible for aggregating and propagating state information among the devices of the system 700B. In this regard, GSADs 715 subscribe to receiving information from all PPDs 705 (e.g., all non-GSAD implementing PPDs) and each other, and PPDs 705 (e.g., non-GSAD implementing PPDs) subscribe to receiving state information from all GSADs 715. Unlike some examples embodiments described previously in which each PPD is a GSAD implementing PPD, these non-GSAD implementing PPDs 705 do not subscribe to one another. In the figures, the SPDs 710 are associated/grouped with particular PPDs 705 and communicate various aspects of their respective state information to one another and to other devices via associated PPDs 705. For instance, PPD1 and SPD1-SPD3 form a first zone group (e.g., Playback zone A), and PPD2 and SPD4-SPD6 form a second zone group (e.g., Playback zone B). PPD1 and PPD2 do not communicate state information of their respective groups directly to one another. Rather, state information aggregated by PPD1 and PPD2 is aggregated by and propagated to other devices of the system via GSAD1 and GSAD2. GSAD1 and GSAD2 subscribe to one another for receiving state information from one another. And as indicated, GSAD2 corresponds to a GSAD implementing PPD (e.g., PPD3) that is grouped with SPD7 and SPD8 to form a third zone group (e.g., Playback zone C).

The configuration of the system 700B of FIG. 7B tends to be more scalable than the system 700A of FIG. 7A because fewer devices are actually performing the state aggregation operations. For example, only two devices (GSAD1 and GSAD2) may be required to maintain the state of all devices of the system.

It should be understood that, functionally, a particular GSAD could also correspond to a PPD and could be part of a group that includes one or more SPDs. That is, the fact that a particular device is a GSAD 715 does not preclude the device from performing other roles within the system 700B. As such, criteria similar to that used to determine whether a device should correspond to a PPD 705 as opposed to an SPD 715 may be used to determine whether a particular device (e.g., a particular PPD) should perform the role of a GSAD 715. (E.g., whether the device is a group coordinator, whether the device has a fast network connection, whether the device receives power from the line, etc.)

An illustrative example of the operation of the system 700B of FIG. 7B involves aggregating and propagating basic state information among the devices of the group. This operation may involve each PPD 705 subscribing to its SPDs 710 to receive the basic state information of its SPDs 710. Each GSAD 715 subscribes to each PPD 705 and to each other GSAD 715 to aggregate the basic state information of all the devices of the system. Each PPD 705 subscribes to each GSAD 715 to receive state information. And each SPD 710 subscribes to its associated PPD 705 to receive the state information from its PPD 705. After these operations are complete, each device of the system 700B will have the basic state information of all other devices of the system 700B.

### 4. Aggregating Devices Subscribed to Particular Primary Devices

FIG. 7C illustrates an example system 700C that is similar in some aspects to the system 700B in FIG. 7B. One difference is that in the system 700C, the GSADs 715 subscribe to particular PPDs 705 to receive state information and to each other, and the PPDs 705 subscribed to particular GSADs 715 to receive state information. This configuration tends to be yet more scalable than the system of FIG. 7B because fewer links are required between the respective devices. This, however, reduces the robustness of the system 700C to an extent. For instance, in this example, if GSAD1 were to fail, communication between PPD1 and PPD2 would not be possible until or unless GSAD2 could be configured to carry the entire state aggregation load of the system 700C.

An illustrative example of the operation of the system 700C of FIG. 7C involves aggregating and propagating basic state information among the devices of the group. This operation may involve each PPD 705 subscribing to its SPDs 710 to receive the basic state information of its SPDs 710. Each GSAD 715 subscribes to a particular PPD 705 and to each other GSAD 715 to aggregate the basic state information of all the devices of the system, and each PPD 705 subscribes to a particular GSAD 715 to receive state information. For example, PPD1 only subscribes to GSAD1, and PPD2 only subscribes to PPD2. GSAD1 only subscribes to PPD1 and GSAD1, and GSAD2 only subscribes to PPD2 and GSAD2. Each SPD 710 subscribes to its associated PPD 705 to receive the state information from its PPD 705. After these operations are complete, each device of the system will have the basic state information of each device of the system 700A.

The systems described in FIGS. 7A-7C utilize multiple PPDs 705 and/or GSADs 715 to aggregate and propagate state information. This, in turn, provides a degree of redundancy. For example, in the system of FIG. 7B, if GSAD1 were to fail, GSAD2 could be used to aggregate and propagate state information with those devices that had been communicating information via GSAD1. Also, the number of SPDs and/or PPDs that can use a particular GSAD 715 may generally be limited by the processing power of the GSAD 715, and so using multiple GSADs 715 facilitates load balancing of the processing requirements of the system. Increasing the number of GSADs 715 also facilitates increasing the area over which the system can be deployed in an economical manner. For example, highspeed communication links can be used to facilitate communications between GSADs 715 and may allow GSADs 715 to communicate over larger distances (e.g., to operate in a large venue such as a convention center), whereas slower-speed communication links may be sufficient to facilitate communications between, for example, SPDs 710 and PPDs 705, and PPDs 705 and GSADs 715.

Further, one or more of the devices can be remote. For instance, a network server can be configured to implement a GSAD 715. One or more layers of a network protocol stack implemented by the server can implement the functionality described above (e.g., a GSAD layer of the protocol stack). SPDs 710, PPDs 705, and other GSADs 715 may communicate state information via, e.g., the Internet, to the server and the state information may be processed at the GSAD layer. Similarly, subscribing devices may communicate subscriptions to the server, and these requests may be serviced by the GSAD layer. The server can then communicate state information corresponding to the subscriptions to the subscribing devices.

Moreover, while the SPDs 710, PPDs 710, and GSADs 715 are described herein primarily in terms of playback devices, the functionality of the SPDs 710, PPDs 710, and GSADs 715 can be implemented and or embodied in other devices that are capable of communicating information. For instance, some examples of network appliances (e.g., routers, switches, etc.), smart appliances (e.g., smart television, refrigerator, etc.), home automation devices (e.g., smart light switches, motion sensors, cameras, etc.) may store state information, may receive subscriptions for the state information and responsively communicate state information that is subscribed to. These devices may also communicate subscriptions to other devices and receive state information from subscribed to devices.

For instance, an example router can communicate state information that specifies the network quality associated with the router. In a multi-router environment, a computer, smartphone, etc., can subscribe to state information that specifies the network quality to determine the router with the best network quality and proceed to route packets of information via that router.

An example smart switch can communicate state information that specifies whether the switch is on, whether there is a load connected to the switch, a dimming state of the switch, etc. A computer, smartphone, etc., can subscribe to one or more aspects of the state information to, for example, dynamically update a GUI indicator to reflect the status of the switch. An example of a smart refrigerator can communicate state information that specifies whether the door is closed, the temperature inside the refrigerator, etc. A computer, smartphone, etc., can subscribe to one or more aspects of the state information to, for example, dynamically update a GUI indicator to reflect the status of the refrigerator.

In some examples, a third-party web server that is remote from these devices can subscribe to aspects of the state information stored/provided by these devices. The web server can generate a webpage with indicators that convey the values of these aspects. The web server can also provide to remote devices access to the state information subscribed to by the remote devices to facilitate controlling the remote devices via a web page.

In some examples, a controller device that hosts a controller application for controlling operations of one or more playback devices may correspond to or reside on an SPD or PPD that communicates information via an associated PPD or GSAD or may correspond to or reside on a GSAD that communicates information via other GSADs and/or PPDs. The controller application may receive state information from one or more devices and process the state information accordingly. For instance, the controller application, via the controller device, may subscribe to receiving battery state information. The controller application may present an interface through which the battery level of various devices of the system can be monitored.

### 5. Rules-Based Propagation of State Information

As indicated above, state information can be divided into categories and rules that govern how/whether a particular device aggregates and propagates the state information may be based on the category to which the state information belongs. For instance, in some examples, state information that is relevant to most devices of a system and/or that is relatively static may be propagated to all the devices of the system. State information that is only relevant to particular devices or groups of devices may be propagated among these devices rather than among all the devices of the system to reduce network traffic related to the propagation of state information within the system. Particular examples of categories of state information that may be propagated in a system that includes playback devices are described in more detail below.

a. Basic State Information

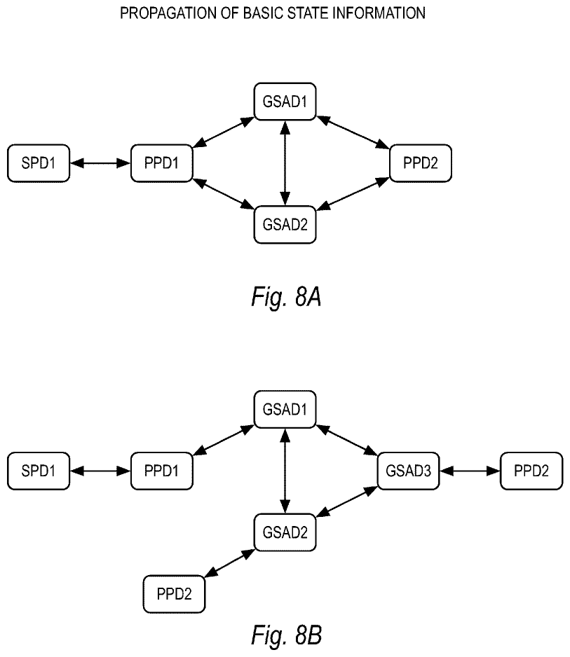

Basic state information is a category of state information that every device possesses, and every other device needs to know. In some examples, the basic state information has few state variables, and the values of those variables are relatively static. As such, the basic state information does not need to be communicated frequently. In operation, basic state information is communicated from each device to every other device. FIGS. 8A and 8B illustrate examples of the propagation of basic state information within a system according to the techniques described in connection with FIGS. 7B and 7C, respectively. Table 1 and Table 2 are examples of basic state information that may be stored in PPD1 and GSAD1, respectively, in connection with FIG. 8A. Tables 3 and Table 4 are examples of basic state information that may be stored in PPD1 and GSAD1, respectively, in connection with FIG. 8B.

TABLE 1

| Device | IPAddr | Name | From |
|---|---|---|---|
| PPD1 | 55 | Den | — |
| SPD1 | 61 | Move | SPD1 |
| PPD2 | 58 | Office | GSAD1 |
| GSAD1 | 59 | Studio | GSAD1 |
| GSAD2 | 60 | Living Room | GSAD1 |

TABLE 2

| Device | IPAddr | Name | From |
|---|---|---|---|
| PPD1 | 55 | Den | PPD1 |
| SPD1 | 61 | Move | PPD1 |
| PPD2 | 58 | Office | PPD2 |
| GSAD1 | 59 | Studio | — |
| GSAD2 | 60 | Living Room | GSAD1 |

TABLE 3

| Device | IPAddr | Name | From |
|---|---|---|---|
| PPD1 | 55 | Den | — |
| PPD2 | 57 | Pool | GSAD1 |
| SPD | 61 | Move | SPD |
| PPD2 | 58 | Office | GSAD1 |
| GSAD1 | 59 | Studio | GSAD1 |
| GSAD3 | 56 | Bath | GSAD1 |
| GSAD2 | 60 | Living Room | GSAD1 |

TABLE 4

| Device | IPAddr | Name | From |
|---|---|---|---|
| PPD1 | 55 | Den | PPD1 |
| PPD2 | 57 | Pool | GSAD2 |
| SPD | 61 | Move | PPD1 |
| PPD2 | 58 | Office | GSAD3 |
| GSAD1 | 59 | Studio | — |
| GSAD3 | 56 | Bath | GSAD3 |
| GSAD2 | 60 | Living Room | GSAD2 |

The basic state information in these tables specifies the IP address and the name of each device of the system along with the identifier of the device (e.g., a UUID) that sourced the state information. For instance, according to Table 1, which is associated with PPD1, basic state information associated with PPD2 was received from GSAD1. On the other hand, the basic state information associated with PPD1 is not “from” another device and therefore, the “from” field specifies a dash.

Indicating the source of the basic state information in each entry in the table allows the device associated with the table to determine whether to propagate the corresponding basic state information to particular devices. For example, the second entry in Table 1 indicates that the basic state information for SPD1 came from SPD1. Therefore, PPD1 should not propagate that particular entry back to SPD1. However, the basic state information in the other entries that did not come from SPD1 can be propagated to SPD1 (if SPD1 subscribes to PPD1 to receive basic state information).

b. Group State Information

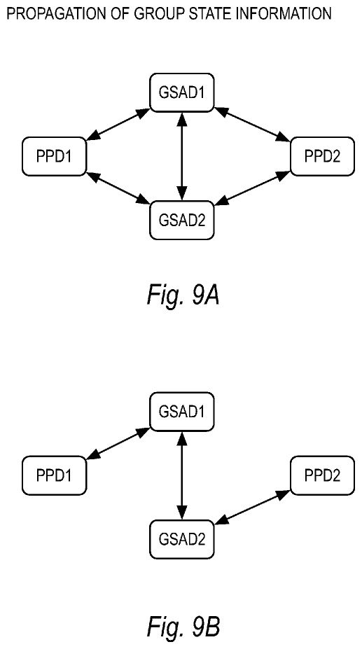

Group state information indicates which devices correspond to primary playback devices or group controllers and the other playback devices that belong to the group. In general, group state information is only required to be known by PPDs and GSADs. FIGS. 9A and 9B illustrate examples of the propagation of group state information within a system according to the techniques described in connection with FIGS. 7B and 7C, respectively. Table 5 is an example of group state information that may be stored in PPD1 and GSAD1 of FIGS. 9A and 9B.

TABLE 5

| Device | Group Controller | Group ID | Members |
|---|---|---|---|
| PPD1 | PPD1 | 123 | PPD1 |
| PPD2 | PPD2 | 456 | PPD2, GSAD1 |
| GSAD1 | GSAD1 | 789 | GSAD1 |

The group state information in this table specifies the group controller, group ID, and group members associated with each device. As indicated, PPD1 and GSAD1 are not grouped with other devices. PPD2 is in a group that includes GSAD1. SPDs associated with a PPD and that together form a playback zone would be indicated as members as well. For example, if SPD1 and SPD2 were grouped with PPD1, the members entry for PPD1 would specify PPD1, SPD1, and SPD2.

c. Battery State Information

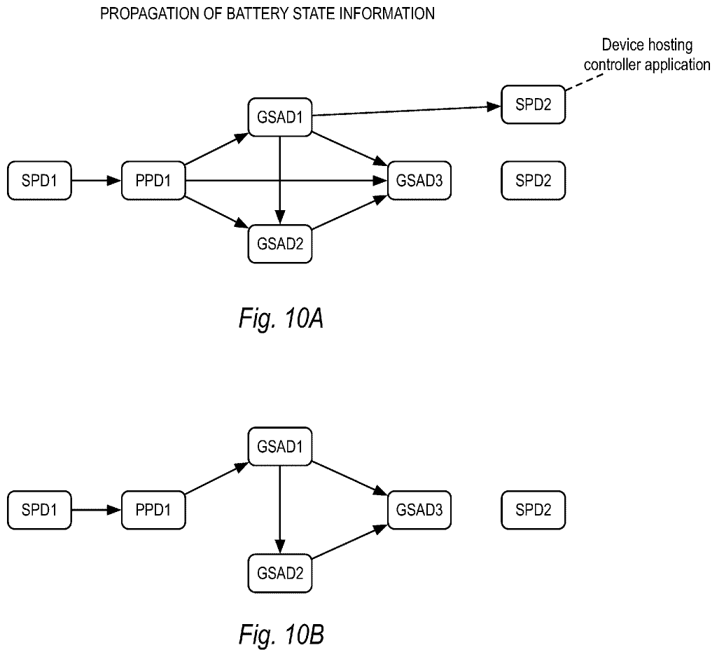

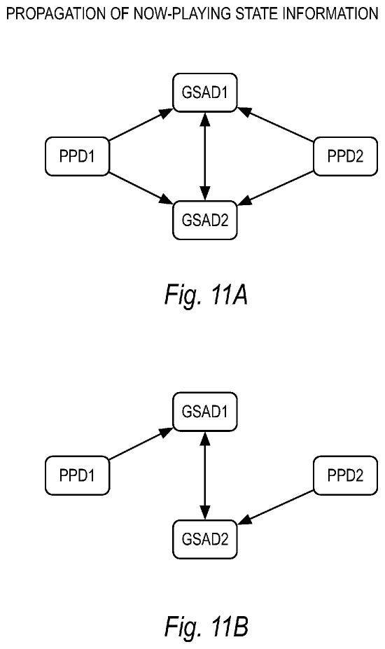

Battery state information generally flows upwards from battery-operated devices to GSADs that may communicate state information to SPDs that host controller applications. As such, there may not be a need to propagate the battery state information toward any other types of SPDs. FIGS. 10A and 10B illustrate examples of the propagation of battery state information within a system according to the techniques described in connection with FIGS. 7B and 7C, respectively. Table 6 is an example of battery state information that may be stored in the PPDs and GSADs of FIGS. 10A and 10B.

TABLE 6

| Device | Power | Charging |
|---|---|---|
| SPD1 | 75% | No |

The battery state information in this table specifies the power level of the battery in SPD1 and also indicates that the battery is not currently being charged. In operation, as the battery level changes, the battery level state information specified in SPD1 will change. The change in the battery level state information will cause SPD1 to propagate the battery state information to subscribing devices. In this example, the battery state information is propagated to subscribing device PPD1. PPD1 likewise propagates the battery state information to subscribing devices. (E.g., GSAD1-GSAD3 in FIG. 10A and GSAD1 in in FIG. 10B). As indicated by the directed lines in the figures, the battery state information is generally only propagated upwards towards the GSADs and not back down to any other devices. In this particular example, however, the system includes SPD2, which hosts a controller application that may generate a GUI that depicts the battery level of the devices of the system. As such, the controller application of SPD2 may subscribe to receiving battery state information from the GSADs of the system, as indicated by the directed arrow to SPD2 in the figure.

d. Now-Playing State Information

Now-playing state information indicates information about the content currently playing within a group. FIGS. 11A and 11B illustrate examples of the propagation of now-playing state information within a system according to the techniques described in connection with FIGS. 7B and 7C, respectively. Table 7 is an example of now-playing state information that may be stored in the devices of the systems. Note in this example, PPD1, GSAD1 and PPD2 are assumed to be group coordinators for a playback group.

TABLE 7

| Device | Metadata | Album Art URI |
|---|---|---|
| PPD1 | ABC | 123 |
| PPD2 | LMN | 456 |
| GSAD1 | XYZ | 778 |

The now-playing state information in this table specifies the metadata of content (e.g., name, artist, album, etc.) and also a URI to perhaps album art associated with the content. As indicated by the directed lines in the figures, the now-playing state information is generally only propagated upwards towards the GSADs and not back down to any other devices. While not shown, an example device of the system (e.g., an SPD) may include a controller application that subscribes to one of the GSADs of the system to receive now-playing state information. The application may include a GUI that presents information specified by the now-playing state information.

e. HTFreq State Information

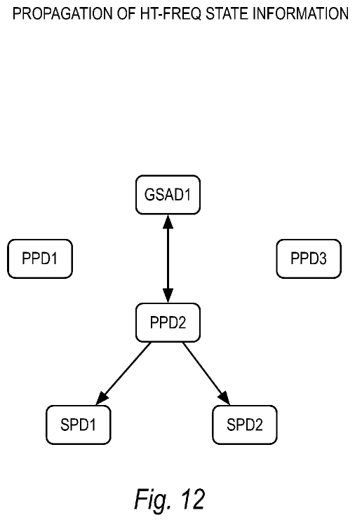

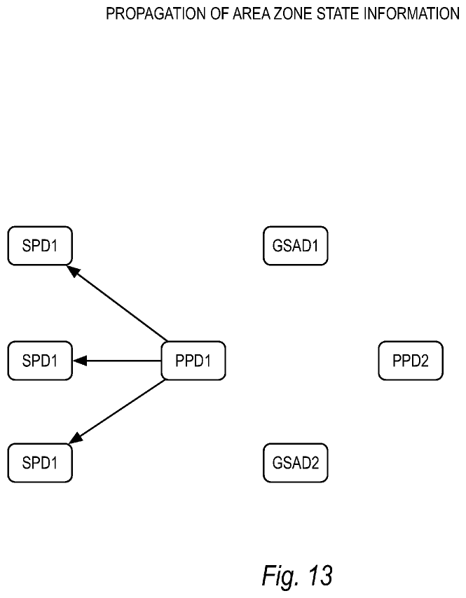

HTFreq State Information indicates the radio channel over which a wireless PPD transmits audio content to its wireless SPDs (e.g., wireless speakers). Wireless PPDs can change this radio channel from time-to-time, for example, when there is wireless congestion around the currently used radio channel. The wireless PPD may communicate and indication of the channel change to its wireless SPDs so that they may listen for audio content on the new radio channel. In some instances, however, a wireless SPD may miss this communication, resulting in a loss of communication. Providing the currently used radio channel as state information allows a wirelessly SPD to re-acquire the audio content. This is illustrated in FIG. 12. Table 8 lists examples of HTFreq state information that may be stored in the wireless PPDs and/or GSADs of FIG. 12 to support these operations.

TABLE 8

| Device | Channel |
|---|---|
| PPD2 | 52 |

f. Area Zone State Information

Area zone state information represents the state variables in an area zone that a PPD needs to communicate to its SPDs so that the devices within the zone can operate as an integrated “player.” For instance, adjustments to the volume, bass, treble, etc., on the PPD should result in the same corresponding adjustments on the SPDs. The propagation of area zone state information is illustrated in FIG. 13. Table 9 lists examples of area zone state information that may be stored in a PPD to support these operations:

TABLE 9

| Device | Volume | Bass | Treble |
|---|---|---|---|
| PPD2 | 45 | +3 | +2 |

### 6. Example Operations

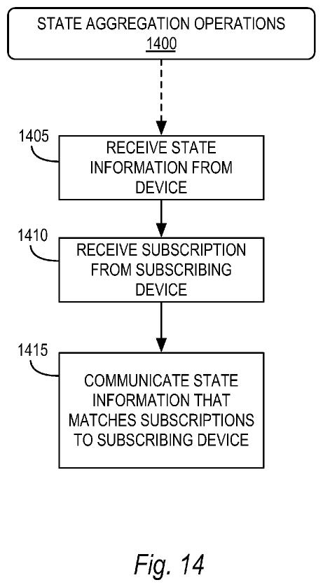

FIGS. 14-21 illustrate examples of operations performed by one or more systems and/or devices described herein. The operations facilitate propagating the state information described above. Some examples of the playback devices 110, control devices 130, etc., described herein are configured to perform these operations while simultaneously playing audio content and/or facilitating the playback of audio content. One or more of the operations may be implemented by instruction code stored within respective storage devices/memories of these devices, which is executable by one or more processors of the devices to configure the devices to perform these operations. Moreover, while the operations are described as being performed by one or more GSADs, the operations may, in some instances, be performed by the PPDs and SPDs.

FIG. 14 illustrates examples of operations 1400 performed by a GSAD that facilitate propagating state information. The operations at block 1405 involve receiving state information from one or more SPDs and/or PPDs. Examples of the state information of a device are represented within the device using a hierarchically structured syntax such as JSON, XML, etc. The following is an example of state information that may be received by a GSAD from a PPD that is part of a group of playback devices:

```
{
    “name”: “Playback zone A”,
    “players”: [
      {
        “playerId”: “RINCON_5CAAFD0518DE01400”,
        “chanMap”: “LF,LF”,
        “name”: “StudioLeft”,
        “volumeBtn”: “zone”,
        “isPrimary”: “true”
      },
      {
        “playerId”: “RINCON_B8E937B7900601400”,
        “chanMap”: “RF,RF”,
        “name”: “StudioRight”,
        “volumeBtn”: “local”
        “isPrimary”: “true”
      }
  ]
}
```

A description of this state information is provided in an earlier section and is not repeated for the sake of brevity.

The operations at block 1410 involve receiving subscriptions from one or more other devices (e.g., from other GSADs and/or PPDs). Some examples of subscriptions that are used to obtain state information stored by a device are specified using a multilevel syntax that facilitates querying/obtaining one or more aspects of the state information. Some examples of the subscription may include one or more wildcards. An example of such a subscription is “/players/playerId/RINCON+”.

The operations at block 1415 involve propagating state information that matches the subscriptions to a subscribing device. Following the example above, the subscription “/players/playerId/RINCON+” causes the GSAD to propagate the following state information to a subscribing device:

```
{
    “players”: [
      {
        “playerId”: “RINCON_5CAAFD0518DE01400”,
      },
      {
        “playerId”: “RINCON_B8E937B7900601400”,
      }
  ]
}
```

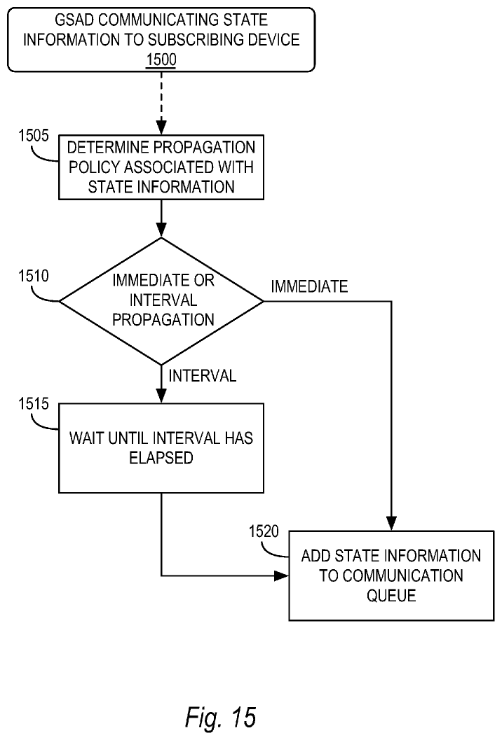

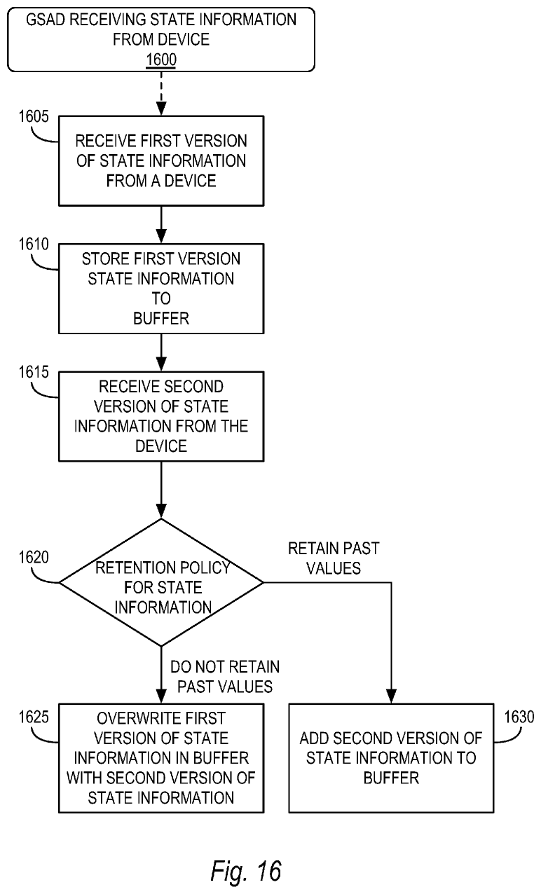

FIG. 15 illustrates examples of operations 1500 performed by a GSAD when communicating state information to a subscribing device 715. The operations 1500 facilitate controlling when state information is communicated to subscribing devices 715. The operations at block 1505 involve determining a propagation policy associated with the state information. In this regard, some examples of state information may be associated with a propagation policy that indicates to the GSAD that the corresponding state information should be immediately propagated/communicated to subscribing devices 715. Another propagation policy may indicate to the GSAD that the corresponding state information should be scheduled to be communicated to subscribing devices 715 after a predetermined interval has elapsed. For example, now-playing state information may be associated with a propagation policy that indicates that the now-playing state information should be communicated five seconds after being generated (e.g., five seconds after the state information has changed).

If, at block 1510, the propagation policy indicates immediate propagation of the state information, then the operations at 1520 are performed. The operations at 1520 involve adding the state information to a communication queue from which the state information and other state information may be communicated to subscribing devices 715. The state information may be communicated after other state information that precedes the state information in the queue has been propagated to subscribing devices 715. In some examples, the propagation policy indicates a priority level (e.g., 1 lowest, 10 highest), and the GSAD is configured to communicate state information in the queue associated with higher priorities before state information in the queue associated with lower priorities.

If, at block 1510, the propagation policy indicates interval propagation or scheduled propagation of the state information, then the operations at block 1515 are performed. The operations at block 1515 involve waiting until a corresponding interval has elapsed before adding the state information to the communication queue, as described above in block 1520.

FIG. 16 illustrates examples of operations 1600 performed by a GSAD when receiving state information from devices and which facilitate determining whether to communicate earlier versions of state information to subscribing devices 715. The operations at block 1605 involve receiving a first version of state information from a device that belongs to a particular category, where the state information specifies a particular value. For example, a first version of group state information associated with a particular playback device 110 may indicate the volume of the playback device 110 as “/Device/P1/Props/Volume=10”. This group state information may be associated with a retention policy that indicates non-retention of the group state information. That is, a retention policy that indicates that past values or versions of this state information should not be retained. A first version of now-playing state information for the same playback device 110 may indicate the currently playing track as “/Device/P1/Props/NowPlaying=XYZ,” and the now-playing state information may be associated with a retention policy that indicates retention of the state information. That is, a retention policy that indicates that past values for this state information should be retained or that a certain number of past values or versions for this state information should be retained. The operations at block 1610 involve storing the first version of state information received above in a buffer.

The operations at block 1615 involve subsequently receiving a second version of the same category of state information from the device. However, the state information may specify a different value. For example, the second version of group state information for the playback device 110 may indicate the volume of the playback device 110 as “/Device/P1/Props/Volume=15”. The second version of the now-playing state information for the playback device 110 may indicate the current track played on the playback device 110 as “/Device/P1/Props/NowPlaying=ABC”.

If, at block 1620, the retention policy associated with the category of state information indicates that past values or versions of this state information should not be retained, then the operations at block 1625 are performed. The operations at block 1625 involve overwriting the older version of the state information in the buffer with the newer version of the state information. Thus, subscribing devices 715 that subscribe to the state information after the initial version of the state information was generated may only receive the later version of the state information, assuming that the later version was generated before the subscribing device 715 subscribed to the state information.

If, at block 1620, the retention policy associated with the category of state information indicates that past values for this state information should be retained or that a certain number of past values for this state information should be retained, then the operations at block 1630 are performed. The operations at block 1630 involve adding the second version of the state information to the buffer so that the buffer stores both the first and second versions of the state information. Subscribing devices 715 that subscribe to the state information after the first and second versions of state information were generated will receive both the first and the second versions of the state information.

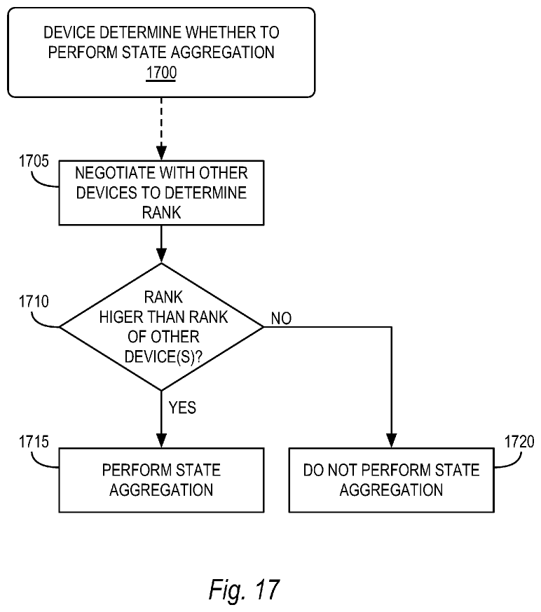

FIG. 17 illustrates examples of operations 1700 performed by a device when determining whether to perform state aggregation. As noted above, some systems may include a variety of playback devices 110, controllers, etc., and there may be more than one device capable of performing state aggregation. The operations at block 1705 involve negotiating with other devices of the system to determine a device rank. For example, a particular device may determine RSSI values associated with other devices capable of performing state aggregation, the number of hops required to communicate to the devices, the types of devices, the hardware capabilities of the devices, the available bandwidth of the devices, etc. The other devices may perform similar operations. Based on these determinations, the devices may agree on a rank to assign to each device. As indicated above, each device can determine its own rank based on information acquired during the device negotiations, thus obviating the need for any centralized decision-making. In some other examples, one of the devices can be designated as the decision maker and can specify the ranks to the other devices.

In some examples, the rank of a particular device is determined based on the role the device plays within a system. For example, a group of playback devices configured to operate in synchrony as part of a home theater system may each be capable of performing state aggregation. The center channel playback device may be configured to receive a stream of audio content from an audio source and to distribute appropriate audio content to the playback devices of the group. Given its centralized role, the center channel playback device may rank higher than the other playback devices and, therefore, be used to aggregate state information among the playback devices of the group. In another example, a non-portable device (e.g., non-portable playback devices) is ranked higher than a portable device (e.g., battery-operated portable playback devices) because the non-portable device may have a more reliable source of power or because the location of the devices may be relatively static.

If, at block 1710, the rank of the device is higher than the rank of the other devices, then the operations at block 1715 are performed, and the device is permitted to perform the state aggregation.

If, at block 1710, the rank of the device is not higher than the rank of the other devices, then the operations at block 1720 are performed, and the device is not permitted to perform the state aggregation.

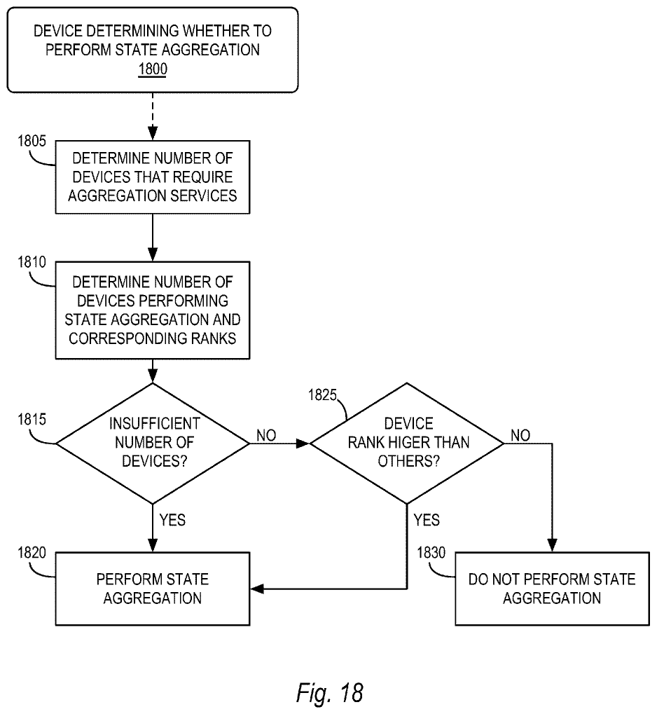

FIG. 18 illustrates examples of operations 1800 performed by a device when determining whether to perform state aggregation. The operations at block 1805 involve determining the number of devices operating in a system that requires state aggregation. The operations at block 1810 involve determining the number of devices performing state aggregation (e.g., the number of GSADs in the system) and the corresponding ranks of those GSADs. For instance, in some examples, the device determines the required number of GSADs required to perform state aggregation to be proportional to the number of devices operating in the system (e.g., one GSAD for every five devices). In some examples, the required number of GSADs is predetermined and/or may be specified according to a table such as:

| # of Players | # of Brokers |
|---|---|
| 1 | 1 |
| 2 | 2 |
| 3-7 | 3 |
| 8-15 | 4 |
| 16-31 | 5 |

The rank of the device and that of the other devices that perform or are capable of performing state aggregation may be determined as described above.

If, at block 1815, there is an insufficient number of GSADs, then the operations at block 1820 are performed, and the device is configured to perform state aggregation.

If at block 1815, the number of GSADs is sufficient, and at block 1825, the rank of the device is higher than the rank of other devices capable of performing state aggregation, then the operations at block 1820 are performed, and the device is configured to perform state aggregation (i.e., becomes a GSAD). Otherwise, the operations at block 1830 are performed, and the device does not perform state aggregation.

The operations described above may be performed on a periodic basis (e.g., every 30 seconds) to provide fallback protection. For example, a particular device that had been configured as a GSAD (e.g., a highest-ranked device) may become inoperative. In this case, at block 1815, one or more devices may determine that there are no longer enough GSADs. At block 1435, the ranks of the devices are determined and/or negotiated among the devices, and at block 1820, the highest ranking of the device may be configured to perform state aggregation. If/when the issue with the original device is resolved, according to the operations above, the original device will begin performing state aggregation, and the device that had taken over this role may cease to perform state aggregation.

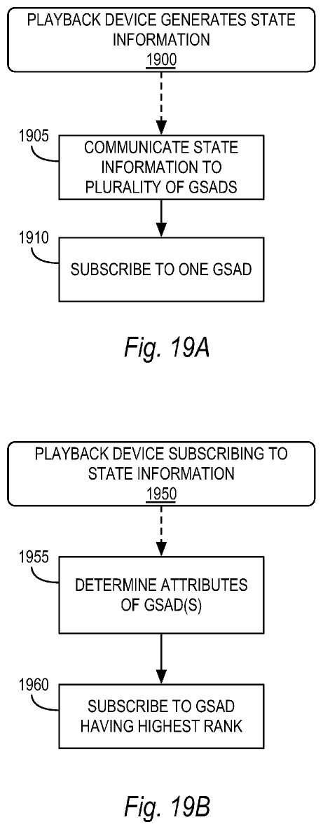

FIG. 19A illustrates examples of operations performed by a playback device 110 when generating state information. The operations at block 1905 involve communicating state information to a plurality of GSADs, and the operations at block 1910 involve subscribing to a particular GSAD. As noted above, in systems that include a plurality of playback devices 110 there may be more than one GSAD operating at the same time. When operating in such systems, the playback device 110 is configured to communicate state information to more than one GSAD and/or to subscribe to more than one GSAD. The GSAD(s) to which the playback device 110 propagates state information and to which the playback device 110 subscribes may be different. Propagation and/or subscribing to more than one GSAD provides a degree of redundancy in case one of the GSADs were to go offline. For example, a particular playback device 110 may propagate state information to a particular GSAD. That GSAD may be moved out of communication range, the battery may fully discharge, etc. By propagating and/or subscribing to a second GSAD, playback operations can continue uninterrupted.

FIG. 19B illustrates examples of operations 1550 performed by a playback device 110 when subscribing to state information. The operations at block 1905 involve receiving one or more properties from GSADs and determining a rank associated with each GSAD. In some examples, the rank is determined based at least in part on the received signal strength indication (RSSI) of the GSAD, a number of network device hops required to communicate information to the GSAD, hardware capabilities of the GSAD, the available bandwidth of the GSAD for aggregating state information, etc.

The operations at block 1960 involve subscribing to the GSAD associated with the highest rank. For example, the playback device 110 subscribes to the GSAD having the highest RSSI, etc.

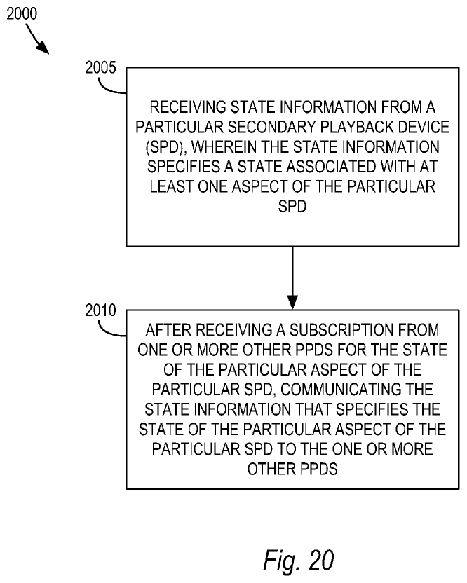

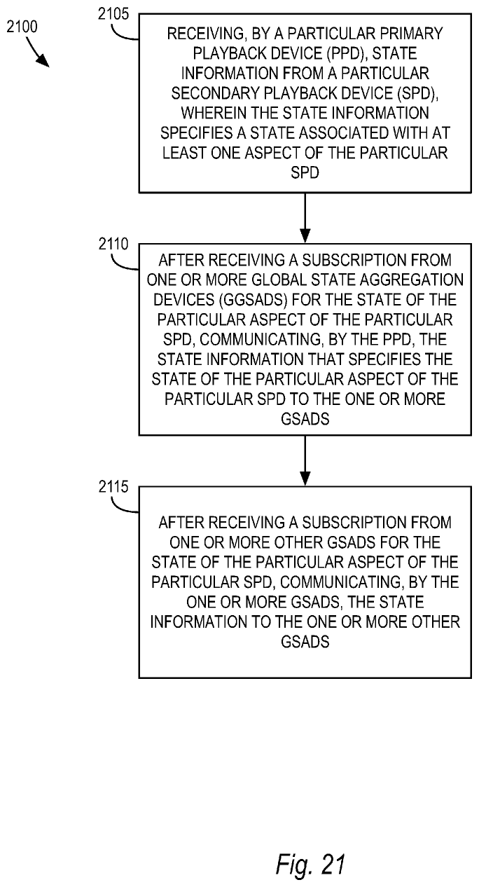

FIG. 20 illustrates examples of operations 2000 performed by a particular primary playback device of a system comprising a plurality of playback devices. The operations at block 2005 involve receiving state information from a particular secondary playback device (SPD). The state information specifies a state associated with at least one aspect of the particular SPD. The operations at block 2010 involve, after receiving a subscription from one or more other PPDs for the state of the particular aspect of the particular SPD, communicating the state information that specifies the state of the particular aspect of the particular SPD to the one or more other PPDs.

In some examples, the system comprises a plurality of PPDs. In these examples, the operations that involve communicating the state information to one or more other PPDs involve the particular PPD communicating the state information that specifies the state of the particular aspect of the particular SPD to every PPD of the plurality of PPDs.

Some examples of the operations involve, after the state of the particular aspect of the SPD has changed, communicating the state information that specifies the state of the particular aspect of the SPD to the PPD.

Some examples of the operation involve receiving a subscription from the particular SPD for the state associated with a particular aspect of one or more other playback devices, communicating a subscription to one or more other PPDs for the state associated with the particular aspect of the one or more other playback devices; receiving the state information associated with the subscription from the one or more other PPDs; and communicating the state information to the particular SPD.

Some examples of the system comprise a plurality of PPDs; and a plurality of SPDs. Each PPD of the plurality of PPDs is grouped with a different subset of the plurality of SPDs. The PPD of each group communicates timing information to the SPDs of the group to facilitate the playback of audio content on the playback devices of the group in synchrony.

In some examples, the state information comprises a multilevel syntax that specifies the at least one aspect of the particular SPD and the corresponding state of the at least one aspect, and the subscription comprises a multilevel syntax that specifies the particular aspect for which the state is desired. In some examples, the multilevel syntax comprises one or more wildcards. And in some of these examples, the multilevel syntax uniquely identifies a particular playback device.

In some examples, each of the plurality of devices specifies different categories of state information. A first category of state information of each of the plurality of devices is propagated to each other playback device of the plurality of playback devices via the particular PPD and the one or more other PPDs. In some of these examples, the first category of state information specifies a network address of a playback device. In some examples, a second category of state information of each of the plurality of devices is propagated only to the particular PPD and the one or more other PPDs. In some of these examples, the second category of state information specifies a battery level of a playback device.

The operations at block 2005 involve receiving, by a particular primary playback device (PPD), state information from a particular secondary playback device (SPD). The state information specifies a state associated with at least one aspect of the particular SPD. The operations at block 2110 involve, after receiving a subscription from one or more global state aggregation devices (GSADs) for the state of the particular aspect of the particular SPD, communicating, by the PPD, the state information that specifies the state of the particular aspect of the particular SPD to the one or more GSADs. The operations at block 2115 involve, after receiving a subscription from one or more other GSADs for the state of the particular aspect of the particular SPD, communicating by the one or more GSADs, the state information to the one or more other GSADS.

In some examples, the system comprises a plurality of GSADs. In these examples, the operations involve communicating, by the one or more GSADs, the state information that specifies the state of the particular aspect of the particular SPD to every GSAD of the plurality of GSADs.

Some examples of operations involve, after receiving a subscription from the particular SPD for the state associated with a particular aspect of another playback device, communicating, by the PPD, the subscription to the one or more GSADs, and after receiving state information from the one or more GSADs associated with the subscription, communicating, by the PPD, the state information to the particular SPD,

In some examples, the system comprises a plurality of PPDs and a plurality of GSADs. Operations in these examples involve every GSAD of the plurality of GSADs communicating subscriptions to every PPD of the plurality of the PPDs and every PPD of the plurality of the PPDs communicating subscriptions to every GSAD of the plurality of GSADs. In some other examples, the operations involve every GSAD of the plurality of GSADs communicating subscriptions to every other GSAD of the plurality of GSADs and each PPD of the plurality of the PPDs communicating subscriptions to a single GSAD of the plurality of GSADs.

In some examples, a first plurality of playback devices is capable of simultaneously operating as both a PPD and a GSAD. In these examples, the operations involve determining, by a particular playback device of the first plurality, a rank based on one or more attributes of the particular playback device; after the rank of the particular playback device is determined to be higher than a rank of a second playback device of the first plurality of playback devices, operating the particular playback device as a GSAD; and after the rank of the particular playback device is determined to be lower than the rank of the second playback device, operating the particular playback device as a PPD and allowing the second playback device to operate as a GSAD.

In some examples, the one or more playback device attributes correspond to one or more of: a type of the particular playback device, a storage capacity of the playback device, a location of the particular playback device, and a network identifier of the particular playback device.

### 7. Additional Examples

Additional examples are disclosed in the clauses described below. The clauses are arranged within groups for clarity. It is understood that the examples set forth in the clauses of each group can be combined with the examples set forth in the other clauses of the group and the examples set forth in the clauses of each other group. Further, the examples set forth in the clauses can be combined with the other examples described herein.

### Group A

Clause 1. A system comprising a plurality of playback devices, wherein each playback device comprises:
one or more processors; and
one or more storage devices that comprise instruction code that is executable by at least one of the one or more processors,
wherein instruction code executed by one or more processors of a particular primary playback device (PPD) causes the particular PPD to:
receive state information from a particular secondary playback device (SPD), wherein the state information specifies a state associated with at least one aspect of the particular SPD, and
after receiving a subscription from one or more other PPDs for the state of the particular aspect of the particular SPD, communicate the state information that specifies the state of the particular aspect of the particular SPD to the one or more other PPDs.

Clause 2. The system according to clause 1, further comprising a plurality of PPDs, wherein the instruction code that causes the particular PPD to communicate the state information to one or more other PPDs causes the particular PPD to:
communicate the state information that specifies the state of the particular aspect of the particular SPD to every PPD of the plurality of PPDs.

Clause 3. The system according to clause 1, wherein instruction code executed by one or more processors of the particular SPD causes the particular SPD to:
after the state of the particular aspect of the SPD has changed, communicate the state information that specifies the state of the particular aspect of the SPD to the PPD.

Clause 4. The system according to clause 1, wherein the instruction code executed by the one or more processors of the particular PPD causes the particular PPD to:
receive a subscription from the particular SPD for the state associated with a particular aspect of one or more other playback devices;
communicate a subscription to one or more other PPDs for the state associated with the particular aspect of the one or more other playback devices;
receive the state information associated with the subscription from the one or more other PPDs; and
communicate the state information to the particular SPD.

Clause 5. The system according to clause 1, further comprising:
a plurality of PPDs; and
a plurality of SPDs, wherein each PPD of the plurality of PPDs is grouped with a different subset of the plurality of SPDs, and wherein the PPD of each group communicates timing information to the SPDs of the group to facilitate playback of audio content on the playback devices of the group in synchrony.

Clause 6. The system according to clause 1, wherein the state information comprises a multilevel syntax that specifies the at least one aspect of the particular SPD and the corresponding state of the at least one aspect, and wherein the subscription comprises a multilevel syntax that specifies the particular aspect for which the state is desired.

Clause 7. The system according to clause 6, wherein the multilevel syntax comprises one or more wildcards.

Clause 8. The system according to clause 7, wherein the multilevel syntax uniquely identifies a particular playback device.

Clause 9. The system according to clause 1, wherein each of the plurality of devices specifies different categories of state information, wherein a first category of state information of each of the plurality of devices is propagated to each other playback device of the plurality of playback devices via the particular PPD and the one or more other PPDs.

Clause 10. The system according to clause 9, wherein the first category of state information specifies a network address of a playback device.

Clause 11. The system according to clause 9, wherein a second category of state information of each of the plurality of devices is propagated only to the particular PPD and the one or more other PPDs.

Clause 12. The system according to clause 11, wherein the second category of state information specifies a battery level of a playback device.

### Group B

Clause 1. A system comprising a plurality of playback devices, wherein each playback device comprises:
one or more processors; and
one or more storage devices that comprise instruction code that is executable by at least one of the one or more processors,
wherein instruction code executed by one or more processors of a particular primary playback device (PPD) causes the particular PPD to:
receive state information from a particular secondary playback device (SPD), wherein the state information specifies a state associated with at least one aspect of the particular SPD, and
after receiving a subscription from one or more global state aggregation devices (GSADs) for the state of the particular aspect of the particular SPD, communicate the state information that specifies the state of the particular aspect of the particular SPD to the one or more GSADs,
wherein instruction code executed by one or more processors of the one or more GSADs causes the one or more GSADs to:
after receiving a subscription from one or more other GSADs for the state of the particular aspect of the particular SPD, communicate the state information to the one or more other GSADS.

Clause 2. The system according to clause 1, further comprising a plurality of GSADs, wherein the instruction code that causes the one or more GSADs to communicate the state information to the one or more other GSADs causes the one or more GSADs to:
communicate the state information that specifies the state of the particular aspect of the particular SPD to every GSAD of the plurality of GSADs.

Clause 3. The system according to clause 1, wherein the instruction code executed by the one or more processors of the particular PPD causes the particular PPD to:
after receiving a subscription from the particular SPD for the state associated with a particular aspect of another playback device, communicate the subscription to the one or more GSADs, and
after receiving state information from the one or more GSADs associated with the subscription, communicate the state information to the particular SPD.

Clause 4. The system according to clause 1, further comprising:
a plurality of PPDs; and
a plurality of GSADs, wherein every GSAD of the plurality of GSADs communicates subscriptions to every PPD of the plurality of the PPDs and every PPD of the plurality of the PPDs communicates subscriptions to every GSAD of the plurality of GSADs.

Clause 5. The system according to clause 1, further comprising:
a plurality of PPDs; and
a plurality of GSADs, wherein every GSAD of the plurality of GSADs communicates subscriptions to every other GSAD of the plurality of GSADs and each PPD of the plurality of the PPDs communicates subscriptions to a single GSAD of the plurality of GSADs.

Clause 6. The system according to clause 1, wherein a first plurality of playback devices are capable of simultaneously operating as both a PPD and a GSAD, wherein the instruction code executed by one or more processors of a particular playback device of the first plurality of playback devices causes the particular playback device to:
determine a rank based on one or more attributes of the particular playback device;
after the rank of the particular playback device is determined to be higher than a rank of a second playback device of the first plurality of playback devices, operate as a GSAD; and
after the rank of the particular playback device is determined to be lower than the rank of the second playback device, operate as a PPD and allow the second playback device to operate as a GSAD.

Clause 7. The system according to clause 6, wherein the one or more playback device attributes correspond to one or more of: a type of the particular playback device, a storage capacity of the playback device, a location of the particular playback device, and a network identifier of the particular playback device.

### Group C

Clause 1. A playback device comprising:
one or more processors; and
one or more storage devices that comprise instruction code that is executable by at least one of the one or more processors,
wherein the playback device corresponds to a primary playback device (PPD) and wherein instruction code executed by one or more processors of the playback device causes the playback device to:
receive state information from a particular secondary playback device (SPD), wherein the state information specifies a state associated with at least one aspect of the particular SPD, and
after receiving a subscription from one or more other PPDs for the state of the particular aspect of the particular SPD, communicate the state information that specifies the state of the particular aspect of the particular SPD to the one or more other PPDs.

Clause 2. The playback device according to clause 1, further comprising a plurality of PPDs, wherein the instruction code that causes the playback device to communicate the state information to one or more other PPDs causes the playback device to:
communicate the state information that specifies the state of the particular aspect of the particular SPD to every PPD of the plurality of PPDs.

Clause 3. The playback device according to clause 1, wherein instruction code executed by one or more processors of the particular SPD causes the particular SPD to:
after the state of the particular aspect of the SPD has changed, communicate the state information that specifies the state of the particular aspect of the SPD to the PPD.

Clause 4. The playback device according to clause 1, wherein the instruction code executed by the one or more processors of the playback device causes the playback device to:
receive a subscription from the particular SPD for the state associated with a particular aspect of one or more other playback devices;
communicate a subscription to one or more other PPDs for the state associated with the particular aspect of the one or more other playback devices;
receive the state information associated with the subscription from the one or more other PPDs; and
communicate the state information to the particular SPD.

Clause 5. The playback device according to clause 1, further comprising:
a plurality of PPDs; and
a plurality of SPDs, wherein each PPD of the plurality of PPDs is grouped with a different subset of the plurality of SPDs, and wherein the PPD of each group communicates timing information to the SPDs of the group to facilitate playback of audio content on the playback devices of the group in synchrony.

Clause 6. The playback device according to clause 1, wherein the state information comprises a multilevel syntax that specifies the at least one aspect of the particular SPD and the corresponding state of the at least one aspect, and wherein the subscription comprises a multilevel syntax that specifies the particular aspect for which the state is desired.

Clause 7. The playback device according to clause 6, wherein the multilevel syntax comprises one or more wildcards.

Clause 8. The playback device according to clause 7, wherein the multilevel syntax uniquely identifies a particular playback device.

Clause 9. The playback device according to clause 1, wherein each of the plurality of devices specifies different categories of state information, wherein a first category of state information of each of the plurality of devices is propagated to each other playback device of the plurality of playback devices via the playback device and the one or more other PPDs.

Clause 10. The playback device according to clause 9, wherein the first category of state information specifies a network address of a playback device.

Clause 11. The playback device according to clause 9, wherein a second category of state information of each of the plurality of devices is propagated only to the playback device and the one or more other PPDs.

Clause 12. The playback device according to clause 11, wherein the second category of state information specifies a battery level of a playback device.

### Group D

Clause 1. A playback device comprising:
one or more processors; and
one or more storage devices that comprise instruction code that is executable by at least one of the one or more processors,
wherein the playback device corresponds to a primary playback device (PPD) and wherein instruction code executed by one or more processors of the playback device causes the playback device to:
receive state information from a particular secondary playback device (SPD), wherein the state information specifies a state associated with at least one aspect of the particular SPD, and
after receiving a subscription from one or more global state aggregation devices (GSADs) for the state of the particular aspect of the particular SPD, communicate the state information that specifies the state of the particular aspect of the particular SPD to the one or more GSADs,
wherein instruction code executed by one or more processors of the one or more GSADs causes the one or more GSADs to:
after receiving a subscription from one or more other GSADs for the state of the particular aspect of the particular SPD, communicate the state information to the one or more other GSADS.

Clause 2. The playback device according to clause 1, further comprising a plurality of GSADs, wherein the instruction code that causes the one or more GSADs to communicate the state information to the one or more other GSADs causes the one or more GSADs to:
communicate the state information that specifies the state of the particular aspect of the particular SPD to every GSAD of the plurality of GSADs.

Clause 3. The playback device according to clause 1, wherein the instruction code executed by the one or more processors of the playback device causes the playback device to:
after receiving a subscription from the particular SPD for the state associated with a particular aspect of another playback device, communicate the subscription to the one or more GSADs, and
after receiving state information from the one or more GSADs associated with the subscription, communicate the state information to the particular SPD.

Clause 4. The playback device according to clause 1, further comprising:
a plurality of PPDs; and
a plurality of GSADs, wherein every GSAD of the plurality of GSADs communicates subscriptions to every PPD of the plurality of the PPDs and every PPD of the plurality of the PPDs communicates subscriptions to every GSAD of the plurality of GSADs.

Clause 5. The playback device according to clause 1, further comprising:
a plurality of PPDs; and
a plurality of GSADs, wherein every GSAD of the plurality of GSADs communicates subscriptions to every other GSAD of the plurality of GSADs and each PPD of the plurality of the PPDs communicates subscriptions to a single GSAD of the plurality of GSADs.

Clause 6. The playback device according to clause 1, wherein a first plurality of playback devices are capable of simultaneously operating as both a PPD and a GSAD, wherein the instruction code executed by one or more processors of a particular playback device of the first plurality of playback devices causes the particular playback device to:
determine a rank based on one or more attributes of the particular playback device;
after the rank of the particular playback device is determined to be higher than a rank of a second playback device of the first plurality of playback devices, operate as a GSAD; and
after the rank of the particular playback device is determined to be lower than the rank of the second playback device, operate as a PPD and allow the second playback device to operate as a GSAD.

Clause 7. The playback device according to clause 6, wherein the one or more playback device attributes correspond to one or more of: a type of the particular playback device, a storage capacity of the playback device, a location of the particular playback device, and a network identifier of the particular playback device.

### B. Using a Single Broker or Multiple Brokers to Share Information

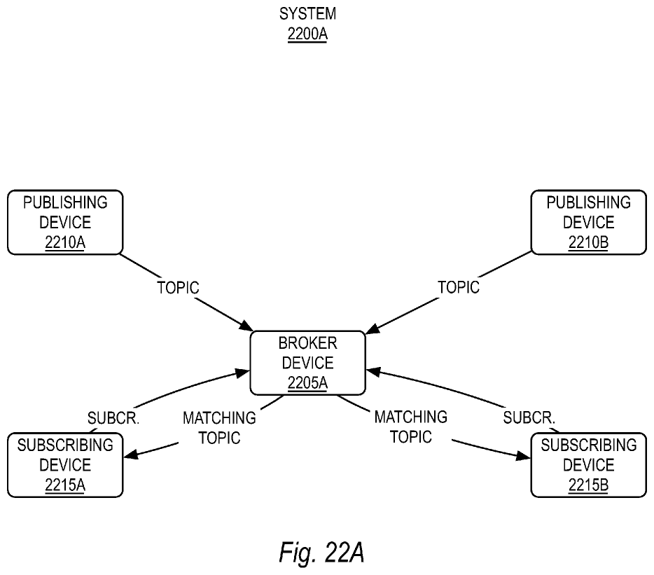

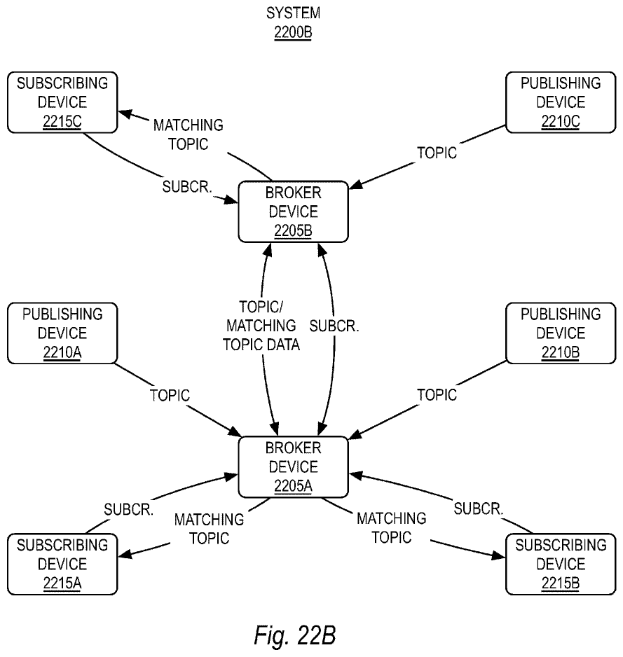

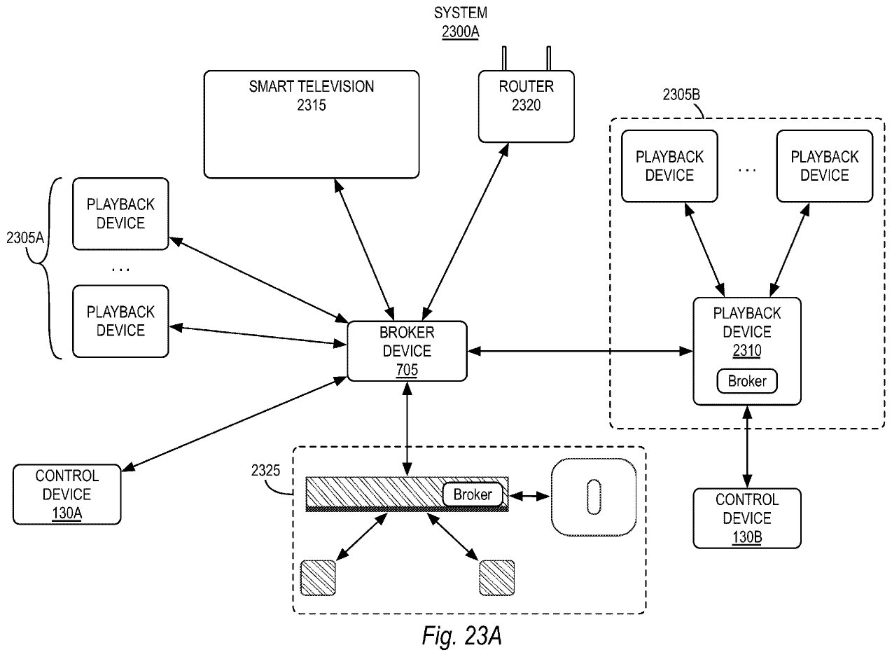

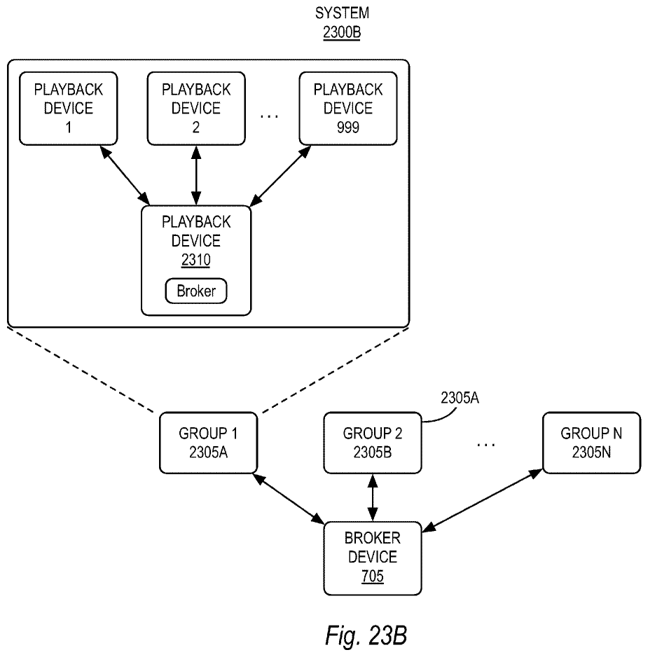

FIG. 22A illustrates an example of a system 2200A in which devices communicate information via a single broker. Devices of the system include a broker device 2205A, publishing devices 2210A, 2210B, and subscribing devices 2215A, 2215B. Examples of devices of the system 2200B shown in FIG. 22B include first and second brokers devices 2205A, 2205B, publishing devices 2210A, 2210B, 2210C, and subscribing devices 2215A, 2215B, 2215C. Other examples can include any number of brokers, publishing devices, and subscribing devices.

As shown in the figures, the first publishing device 2210A and the second publishing device 2210B publish topics to the first broker device 2205A. The first subscription device 2215A, and the second subscription device 2215B subscribe to the first broker device 2205A to receive topics. The first broker device 2205A forwards topics that match subscriptions to corresponding subscribing devices 2215A, 2215B.

Some examples of the subscription correspond to a topic filter. When the topic matches the topic filter, the broker 2205 communicates the topic to the subscribing device 2215. Some examples of the topic filter comprise wild cards. For example, a subscription such as “/Device+/Core/Model No” (“+” being a wildcard) causes the broker 2205 to communicate the model number (more specifically, the topic that specifies the model number) for any devices that publish the model number using the same topic syntax to subscribing devices 2215. A subscription such as “/Device/P1/Core/#” (“#” being a wildcard) causes the broker 2205 to communicate all the core properties of device P1 to subscribing devices 2215. Some examples of the topic filter are expressed using regular expression syntax, which facilitates more complex topic filter matching by the broker 2205.

FIG. 22B illustrates an example of a system 2200B in which devices communicate information via multiple brokers. In addition to the devices above, the system 2200B includes a third publishing device 2210C that publishes topics to a second broker device 2205B, and a third subscription device 2215C that subscribes to the second broker device 2205B to receive topics. The second broker device 2205B forwards topics that match the subscription to the subscribing device 2215B. In some examples, the first broker 2205A and the second broker 2205B publish topics to one another and subscribe to one another to receive topics that match their respective subscriptions. In this regard, the first subscribing device 2215A may subscribe to a topic that is published by the third publishing device 2210C. The first broker 2205A may, in this example, subscribe to the second broker 2205B on behalf of the first subscribing device 2215A to receive topics from the third publishing device 2210C.

Using multiple brokers to communicate information provides a degree of redundancy. For example, if a first broker were to fail, a second broker can establish communications links with the publishing devices and subscribing devices that had been using the first broker to facilitate communications. Also, the number of devices that can use a given broker is generally limited by the processing power of the broker, and so, using multiple brokers facilitates load balancing of the processing requirements of the system. Increasing the number of brokers also facilitates increasing the area over which the system can be deployed in an economical manner. For example, highspeed communication links can be used to facilitate communications between brokers and may allow the brokers to communicate over larger distances (e.g., to operate in a large venue such as a conventions center), whereas slower-speed communication links may be sufficient to facilitate communications between publishing devices, subscribing devices and their corresponding brokers.

While each device is shown as corresponding to one of three entities (i.e., publisher, subscriber, or broker), it is understood that some examples of the device can implement all three entities. For example, some devices may publish topics, broker topics, and subscribe to topics. In some examples, a device publishes topics to its own/implemented broker 2205 and/or subscribes to topics brokered by its own/implemented broker 2205. Further, while the broker devices 2205A, 2205B, publishing devices 2210A, 2210B, 2210C and subscribing devices 2215A, 2215B, 2215B are shown communicating information directly to one another, any number of intermediate network devices (e.g., routers, switches, etc.) can be communicatively coupled between the devices to facilitate communicating information between the devices.

Further, one or more of the devices can be remote. For instance, a network server can be configured to implement a broker. One or more layers of a network protocol stack implemented by the server can implement the broker functionality described above (e.g., a broker layer of the protocol stack). Publishing devices may publish topics via, e.g., the Internet, to the server and those topics may be processed at the broker layer. Similarly, subscribing devices may communicate subscriptions to the server, which may be processed at the broker layer. The server can then communicate topics corresponding to the subscriptions to the subscribing devices.

Moreover, while the brokers, publishers, and subscribing devices are described herein primarily in terms of a playback system, these devices can be implemented in other devices that are capable of communicating information. For instance, some examples of network appliances (e.g., routers, switches, etc.), smart appliances (e.g., smart television, refrigerator, etc.), home automation devices (e.g., smart light switches, motion sensors, cameras, etc.) can implement a broker, publish topics, and/or subscribe to topics.

An example of a router can publish topics that specify the network quality associated with the router. In a multi-router environment, a computer, smartphone, etc., can subscribe to topics that specify the network quality to determine the router with the best network quality and proceed to route packets of information via that router.

An example of a smart switch can publish topics that specify whether the switch is on, whether there is a load connected to the switch, a dimming state of the switch, etc. A computer, smartphone, etc., can subscribe to one or more of these topics to, for example, dynamically update a GUI indicator to reflect the status of the switch. An example of a smart refrigerator can publish topics that specify whether the door is closed, the temperature inside the refrigerator, etc. A computer, smartphone, etc., can subscribe to one or more of these topics to, for example, dynamically update a GUI indicator to reflect the status of the refrigerator.

In some examples, a third-party web server that is remote from these devices can subscribe to topics published by these devices. The web server can generate a webpage with indicators that convey the values of these topics. The web server can also publish topics that are subscribed to by remote devices to facilitate controlling the remote devices via a web page.

1. Example Systems of Devices that Communicate Information Via Brokers

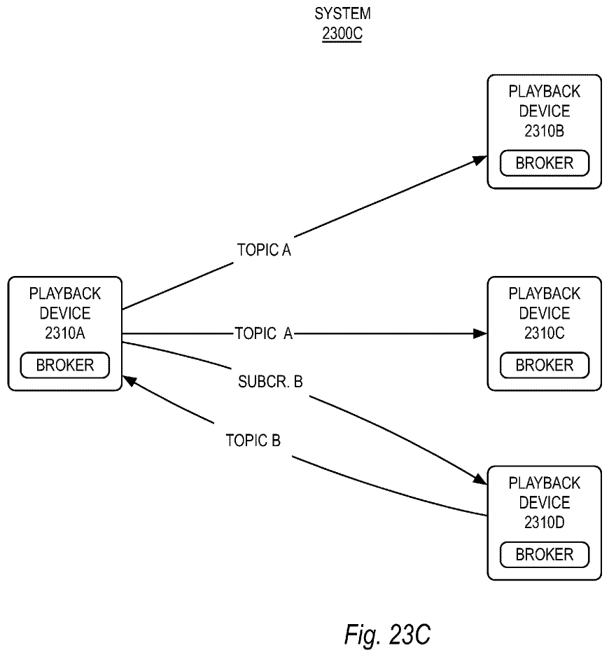

FIG. 23A illustrates an example of a system 2300A that includes various types of devices that communicate information via brokers. Shown is a broker device 2205, a first group of playback devices 2305A, a second group of playback devices 2305B, a first control device 130A, a second control device 130B, a smart television 2315, a router 2320, and a home theater playback system 2325. While the broker device 2205 is shown as a separate device of the system 2300A, it should be understood that the broker device 2205 can correspond to a broker implemented by one of the other devices of the system 2300A.

The second group of playback devices 2305B may operate as a bonded group. For example, the second group of playback devices 2305B may play audio content in synchrony with one another. In this regard, one of the playback devices 2310 may perform the functions of a group controller, such as receiving audio data from an audio source and communicating the audio data in a coordinated fashion to other playback devices of the group 2305B. In the illustrated example, this playback device 2310 also implements a broker configured to broker information between the second group of playback devices 2305B and the other devices illustrated in the figure. For example, the playback device 2310 may subscribe to the broker device 2205 to discover devices within the system capable of streaming information from the Internet. The router 2320 may publish a topic to the broker device 2205 indicating that it can perform this operation. The playback device 2310 and the router 2320 may then coordinate further operations to facilitate streaming the information from the Internet.

The playback devices of the home theater playback system 2325 may operate as a bonded group (e.g., left, center, right, sub-channel, etc.). In the illustrated example, the center channel playback device may perhaps perform the functions of the group controller and also implement a broker configured to broker information among the playback devices of the home theater playback system 2325 and the other devices illustrated in the figure. For example, the smart television 2315 may perhaps subscribe to the broker device 2205 to discover devices within the system capable of playing multichannel (e.g., 5.1 channel) surround sound. The center channel playback device may publish a topic via its own broker to the broker device 2205, indicating that it can perform this operation. The smart television 2315 and the center channel playback device may then coordinate further operations to facilitate synchronized playback of video and audio content.

FIG. 23B illustrates an example of a system 2300B that includes a large number of devices that communicate information via brokers. As noted earlier, in some conventional systems, the number of communication links between devices grows exponentially with the number of devices. By communicating information via one or more brokers, the number of communication links can be reduced considerably. This, in turn, facilitates quickly propagating state information throughout systems having 100s or 1000s of devices. In the example shown in FIG. 23B, a first group of devices 2305A comprises 1000 playback devices. A particular playback device 2310 of the group 2305A implements a broker for receiving topics and subscriptions from the other playback devices of the group 2305A and may also serve as a group controller for coordinating the streaming of audio content to the other playback devices of the group 2305A. The first group of devices 2305A devices may be one of many such groups of devices, each comprising its own broker and perhaps a group controller. In FIG. 23B, the brokers of the respective groups communicate to a common broker device 2205, which can be a standalone broker device or can correspond to a broker implemented by one of the devices in one of the groups.

FIG. 23C illustrates an example of a device 2310A of a system 2300C communicating topics to multiple broker devices 2310B, 2310C. The device 2310A is shown as subscribing to one broker device 2310D, but in some examples, the device 2310A can also subscribe to the other broker device devices 2310B, 2310D. Publishing and/or subscribing to more than one broker device provides a degree of redundancy in the event that one of the broker devices were to go offline. For example, a particular playback device may publish topics to a broker of a portable playback device and to the broker of a non-portable playback device. The portable playback device may move out of communication range, the battery may fully discharge, etc. Other devices subscribing to the now offline broker of the portable playback device can discover and subscribe to the broker of the non-portable playback device to which the particular device had published topics to continue with their respective operations.

### 2. Examples of Topics and Subscriptions Communicated Via a Broker

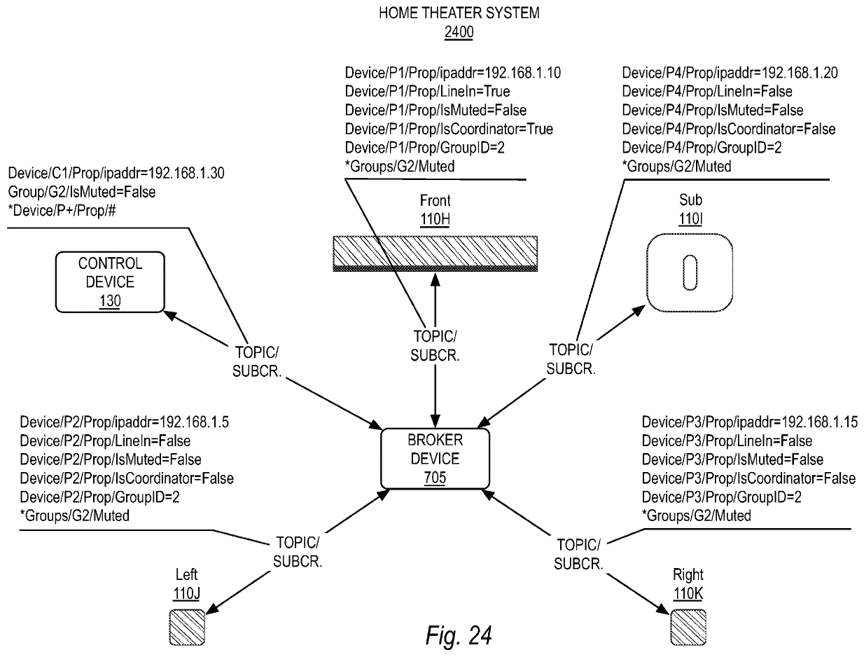

FIG. 24 illustrates examples of topics and subscriptions communicated within an example of a home theater system 2400. The aspects described herein can be applied to other systems of playback and/or other devices. Referring to the figure, the system 2400 includes left and right surround speakers 110J, 110K, a front speaker 110H, a subwoofer 110I, a control device 130, and a broker 2205. The broker 2205 can correspond to a standalone device or can be integrated with one of the other devices shown in FIG. 23A.

Examples of the devices are configured to publish topics to the broker 2205, subscribe to topics brokered by the broker 2205, and receive topics that match the subscriptions from the broker 2205. Examples of topics and subscriptions communicated by each device are shown in FIG. 23A. For example, as shown, each device publishes its IP address using the topic “/Device/xx/Prop/ipaddr=xxx.”

Examples of topics published by the playback devices 110 include “/Device/Px/Prop/LineIn=True/False”, “/Device/Px/Prop/IsMuted=True/False”, “/Device/Px/Prop/IsCoordinator=True/False”, and “/Device/Px/Prop/GroupID=xx”. The “/Device/Px/Prop/LineIn=True/False” topic may be used to indicate whether the playback device 110 includes a line-in connection and, if so, whether the line-in connection is communicatively coupled to an audio source. The “/Device/Px/Prop/IsMuted=True/False” topic may be used to indicate whether the playback device 110 is muted. In some examples, the “Px” term is different for each playback device 110. That is, each topic uniquely specifies a particular playback device 110.

The “/Device/Px/Prop/IsCoordinator=True/False” and “/Device/Px/Prop/GroupID=xx” topics indicate whether the playback device 110 is a group coordinator and the group ID of the group. In FIG. 23A, playback device 110H is a group coordinator (as indicated by the topic “/Device/P1/Prop/IsCoordinator=True). Therefore, in operation, playback device 110H performs functions for helping carry out groupwise playback of audio by the other playback devices 110 of the system 2300. These functions include, for example, (i) obtaining audio content from an audio source; (ii) generating playback timing for the audio content, where the playback devices 110 in the playback group (including the group coordinator) use the audio content and the playback timing to play audio based on the audio content in a groupwise fashion; (iii) playing the audio based on the audio content in synchrony with the other playback device 110 in the group; and (iv) transmitting the audio content and the playback timing information to the other playback device 110 in the group. In some examples, the group coordinator functions additionally include providing clock timing to the group member, where the playback devices 110 in the paired configuration (including the group coordinator) use the clock timing, the audio content, and the playback timing to play audio based on the audio content in a groupwise fashion. In some examples, the device that corresponds to the group coordinator implements the broker 2205 that facilitates communications between the other devices.

An example of the control device 130 can subscribe to “/Device/P+/Prop/#” to receive all the properties of all the playback devices 110. From this information, the control device 130 can determine whether any playback devices 110 belong to a group (e.g., group G2). The control device 130 can then publish the topic “Group/G2/IsMuted=True/False” to mute and unmute playback devices 110 that belong to group 2. The playback devices 110 subscribe to “Groups/G2/Muted” to receive the “Group/G2/IsMuted=True/False” topic communicated from the control device 130 and responsively mute or unmute.

As noted above, the topics and subscriptions shown in FIG. 24 are merely examples. Examples of topics and subscriptions can also be used to communicate other state information such as the state information communicated in conventional systems using the DP, GM, ZGT, and/or AVT UPnP services described above. For example, a device can communicate a topic to indicate any groups to which it belongs and subscribe to the same topic to determine groups to which other devices belong. An example of a controller that subscribes to this topic can determine whether a particular playback device is in a group and, if not, communicate a topic subscribed to by the playback device that causes the playback device to join the group.

Similarly, a control device or another device) can, for example, communicate topics subscribed to by playback devices or other devices that cause these devices to change the state of a status LED (e.g., on/off/dimmable state, etc.), become part of a bonded zone with other devices, change volume, etc. These devices may also communicate topics to indicate their current state. For example, if the name of a playback device changes to “Living Room,” the playback device may, in response to the change, communicate a topic that indicates the name of the playback device. If a volume up/down button, mute button, etc., is actuated on a playback device, control device or other device, the device can send a topic that specifies that corresponding button was pressed (e.g., click event/topic), is being pressed (e.g., button down event/topic), was just released (e.g., button up event/topic), etc. A controller, playback device, or other device that has subscribed to one of these topics can then responsively update a user interface to convey this information, increase/decrease a volume level, etc.

A non-exhaustive list of examples of additional topics that can be used to communicate information within, for example, a system of playback devices, is shown below in Table 1.

TABLE 1

| Devices | Values |
|---|---|
| /Device/Px/Prop/Core | UUID |
| | SerialNum |
| | ModelType |
| | SoftwareVers |
| | IpAddr |
| | Capabilities |
| | VoiceControllable |
| | HasBattery |
| | RSSI |
| Device/Px/Prop/Services | Alexa ® |
| | Google Assistant ® |
| /Device/Px/Props/Group | GroupID |
| | IsCoordinator |
| | PrimaryDdeviceId |
| | BondedZoneInfo |
| /Device/Px/Props/Extended | Line-in |
| | LED |
| /Device/Px/Props/Inputs/Microphone | IsOn |
| /Device/Px/Props/PowerSource | Line |
| | Battery |
| /Device/Px/Props/PoweredState | On |
| | LowPowerMode |
| | StandbyMode |
| /Device/Px/Props/Sensors/Light | IsOn |
| /Device/Px/Props/Sensors/Temperature | TemperatureValue |
| /Device/Px/Props/Sensors/Proximity | IsObjectNear |

Additional examples of topics and subscriptions can be used to communicate information between various devices. For example, some playback devices or other devices are configured to communicate information that facilitates determining the relative locations of the devices within an environment. These devices may communicate this information via topics and subscriptions. For instance, some examples of devices may include communication hardware such as Bluetooth, WIFI or ultra wide-band ranging technology (UWB). Some examples of devices may include sensors that facilitate signaling via acoustic signals, ultrasound, and/or other similar signaling technology. The positioning accuracy afforded by these technologies varies. For example, UWB may provide high precision distance measurements, whereas WIFI (e.g., using RSSI signal strength measurements) or ultrasound may provide “room-level” topology information (e.g., presence detection indicating that a particular device is within a particular room or space of the environment). Some examples of these devices may publish one or more topics that specify the type of hardware (if any) the device has (e.g., . . . /hasUWBTransceiver, . . . /hasBluetoothTransceiver, . . . /hasWIFITransceiver, . . . /hasUltrasoundSensor). Additionally, these or other topics may specify values associated with metrics generated by the hardware, such RSSI levels, acoustic distance measurements, UWB range measurements, etc.

Some examples of the devices (e.g., controllers) may include a positioning system application configured to process information received from other devices to determine the relative locations of the devices and/or the topology of the device network. In this regard, some examples of these devices may subscribe to the topics above to identify devices that have hardware capabilities that facilitate location determination and the corresponding metrics generated by the hardware. The positioning system application may receive information, via a broker, that facilitates determining the hardware capabilities and corresponding metrics of any number of devices within the device network. For example, the positioning system application may be configured to determine the approximate location of a device or to detect the presence of a device within an environment based on ultrasound distance measurements published via topics. The positioning system application may be configured to use RSSI measurements published via topics to confirm the presence of the device within the environment and/or to supplement this information with more precise localization information. The positioning system application may yet be further configured to use UWB measurements published via topics to determine even more precise localization information.

In some examples, the positioning system application uses the combined information published via topics by several devices to determine relative locations of devices and/or the device network topology. This location information may, in turn be used to support, for example, the implementation of voice disambiguation features and arbitration between different devices receiving the same voice inputs. The location information may facilitate automatic configuration or reconfiguration of device groups (e.g., automatically assigning different devices in proximity to one another to specific channels of a home theater environment). The location information may facilitate automatic/dynamic room assignment for devices (e.g., portable devices) or their associated docks. The location information may facilitate determining the contextual orientation of controller devices (e.g., to allow the controller to automatically select a playback device that is in proximity/in front of the user holding the controller).

### 3. Using Topics and Subscriptions to Control Devices

As indicated above, the techniques described herein for controlling aspects of devices of a networked system of devices via topics and subscriptions are more efficient than techniques used in conventional systems of networked devices.

For example, in some conventional playback systems, adjustment of a parameter such as the volume, bass, treble, etc., involves receiving, on a control device, an indication to adjust the parameter and then communicating, by the control device, one or more instructions to each playback device to adjust the parameter. This may not present any issues when the number of playback devices is relatively small (e.g., less than ten). In this case, the control device can, in relatively short order, send the parameters to all the playback devices. In some systems these parameters are passed from playback device to playback device in a daisy-chained fashion. Again, this may not present any issues when the number of playback devices is relatively low.

However, in larger systems (e.g., more than ten), sending parameters by the control device to each playback device (or via daisy chaining) may take considerable processing resources and/or lead to a less than satisfactory user experience. For example, there may be a noticeable lag between when the volume is lowered on the first device and when the volume is lowered on the second device. Further, the control device may become unresponsive when sending out large numbers of parameters, further frustrating the user experience.

These issues are ameliorated by communicating the information via a broker. For instance, in an example, to adjust the volume of a group of playback devices, the control device publishes a volume topic to a broker that specifies the current volume level (i.e., a single topic message is sent). Playback devices of the system subscribe to the volume topic and will receive the specified volume from the broker. Thus, from the perspective of the control device, a single volume change message is all that is required to adjust the volume of any number of playback devices. This frees processing resources of the control device, potentially improving user experience. Further, the broker may be better suited to broadcasting the topics to many playback devices than the control device. For example, the broker may have more robust processing capabilities, be powered from the line, have high-speed network interfaces, etc.

Other procedures performed by playback device systems can be improved using the techniques described herein. For example, as noted above, in some conventional playback systems, various services are implemented on each playback device (e.g., device properties (DP) service, group management (GM) service, zone group topology (ZGT) service) to facilitate determining the topology of a particular group playback devices. Control devices subscribe to the services of each of the devices to identify the playback devices 110 and audio groups that are present within a particular environment and/or that are configured into a logical group (e.g., home theater group, left-right pair, zone group, etc.). However, subscribing to each device is not practical when there are a large number of devices. For example, the control device may have to maintain unicast and multicast IP addresses associated with each playback device and generally devote more network resources to maintaining links to the other devices.

Using the brokering techniques described herein can improve upon this. For example, in a brokered topology, each playback device may publish a group membership topic to the broker that specifies the group to which the playback device belongs (e.g., home theater group, left-right pair, zone group, etc.). A control device can subscribe to a broker to receive topics that specify group membership. When a playback device joins a group (or changes groups, leaves a group, etc.), the playback device publishes a group membership topic that specifies the group membership status of the playback device. The topic is then forwarded by the broker to the control device. In this case, the control device only needs to maintain a communication link to the broker and does not need to have or maintain any direct knowledge (e.g., IP address) of the playback devices.

### 4. Maintaining Topic Value History

In some examples, by default, brokers only communicate topics to subscribing devices 2215 after subscriptions are received. For example, if a particular playback device 110 publishes the topic “/Device/P1/Props/Volume=10” at a first time and then later publishes the topic “/Device/P1/Props/Volume=15” in response to the volume being increased on the playback device 110, a device that subscribes to the topic (e.g., the control device 13) after the first topic is published will only receive the most recent topic (i.e., “/Device/P1/Props/Volume=15”). In some examples, the playback device 110 can specify a retention policy to associate with the topic to indicate whether past values associated with the topic should be maintained. For example, the playback device 110 can specify a retention policy that indicates to the broker 2205 that past values for a topic such as “/Device/P1/Props/NowPlaying=XYZ” should be maintained so that a subscribing device 2215 can obtain a list of content that was played on the playback device 110. Some examples of playback device properties for which past values may be maintained (as indicated by a corresponding retention policy) include metadata associated with content played on the playback device 110 and a room location of the playback device 110. Maintaining the past room location values facilitates predicting future locations of the playback device 110 (e.g., a portable playback device), which can be used when determining whether to automatically group the playback device 110 with other playback devices 110 in a particular room. Some examples of playback device properties for which past values may not be maintained include information that tends to be static such as the volume level of the playback device 110, the playback state of the playback device 110 (e.g., playing, paused, etc.), the group membership of the playback device 110, the model and the serial number of the playback device 110, and the calibration state of the playback device 110.

In some examples, the retention policy may indicate the number of past values that should be maintained (e.g., the last ten songs). In some examples, if the retention policy indicates that only the current value of the topic should be maintained and communicated to subscribing devices, earlier values of the topic may still be maintained for a time but indicated as removable from storage by the broker 2205 (e.g., during a garbage collection operation of the broker). In some examples, the broker 2205 may maintain a timestamp associated with the publication of such topics to facilitate determining whether particular past values for the topic have already been sent (e.g., so that devices that have already received some of the past values are not inundated with redundant messages).

### 5. Scheduling Timing of Topic Communications to Subscribing Devices

In some examples, by default, after a subscription is received by the broker 2205, the broker 2205 communicates topics to subscribing devices 2215 a nominal amount of time afterward. For example, the broker 2205 may add the topic to a queue of topics that will be communicated as soon as practicable (e.g., limited only by processor speed, network speed, network congestion, etc.). In some examples, a topic may be scheduled for communication. For example, a publishing device 2210 may indicate that a topic should be communicated to subscribing devices 2215 at a particular absolute time, relative time (e.g., relative to when the topic is published or when a corresponding subscription is received), etc. In this regard, in some examples, the playback device 110 can specify a propagation policy to associate with the topic to indicate to the broker 2205 whether the topic should be immediately propagated/communicated or scheduled to be communicated after a predetermined interval has elapsed. For example, the playback device 110 can specify a propagation policy that indicates that a topic such as “/Device/P1/Props/NowPlaying=XYZ” should be communicated two seconds after being published. In some examples, the propagation policy indicates a topic priority (e.g., 1 lowest, 10 highest) and the broker 2205 is configured to communicate topics having higher priorities before topics having lower priorities.

### 6. Discovering Topics Published by Devices

In general, subscribing devices 2215 need to know what topics are published by a publishing device 2210 to subscribe to the topics (e.g., so that an appropriate topic filter can be specified in the subscription). Therefore, some examples of the subscribing devices 2215 are configured to initially subscribe to a topic using a subscription such as “Devices/+,” which causes the broker 2205 to communicate all matching device topics to the subscribing device 2215. Later, and after determining the topics published by the relevant device, the subscribing device 2215 can communicate a message to the broker 2205 to unsubscribe from receiving topics that match the “Devices/+” subscription.

### 7. Offering Broker Service According to Device Rank

Some examples of the devices are configured to determine respective ranks associated with different brokers 2205 and to publish topics to the broker 2205 with the highest rank and/or subscribe to the broker 2205 with the highest rank. For example, some examples of the playback device 110, control device 130, etc., determine the rank of each broker 2205 based at least in part on broker properties. Some examples of the devices determine the rank of each broker 2205 based at least in part on the respective receive signal strength indication (RSSI) values of the brokers, where brokers 2205 associated with higher RSSI values are ranked higher. Some examples of the devices determine the rank of each broker 2205 based at least in part on the respective number of network device hops required to communicate information to the corresponding brokers, where brokers 2205 associated with a lower number of network hops are ranked higher. Some examples of the devices determine the rank based at least in part on the hardware capabilities of the broker 2205 (e.g., amount of storage capacities, processor speed, network speed, network type (wired/wireless), etc.), where brokers 2205 having better/faster hardware performance are ranked higher. Some examples of the devices determine the rank of each broker 2205 based at least in part on the available bandwidth for offering brokering services, where brokers 2205 that have more bandwidth to broker information are ranked higher. The bandwidth for a particular broker 2205 may be determined based at least in part on the capabilities (e.g., hardware and software capabilities) of the broker 2205 and the number of devices publishing and/or subscribing to the broker 2205.

In some examples, the rank of the broker 2205 is determined based on the role the broker 2205 plays within a system. For example, a group of playback devices configured to operate in synchrony as part of a home theater system 2400 may each be capable of implementing a broker 2205. The front channel playback device 110H may be configured to receive a stream of audio content from an audio source and to distribute appropriate audio content to the playback devices of the system 2400. Given its centralized role, the broker 2205 of the front channel playback device 110H may rank higher than the other playback devices and, therefore, be used to broker information (e.g., state information) among the playback devices of the system 2400.

In another example, a broker 2205 of a non-portable playback device is ranked higher than a broker 2205 of a portable playback device because the non-portable playback device may have a more reliable source of power or because the location of the playback device is relatively static.

In some examples, devices are assigned to different rank categories (e.g., Category A, B, C, etc., devices). Category A devices may always rank higher than category B, and category B devices may always rank higher than category C devices, and so on. Category A devices may include non-battery powered devices, devices having wired network connections, devices having significant processing bandwidth, etc. Category B devices may include portable/battery-powered devices, devices having an 802.11-based network connection, etc. Category C devices may include devices only capable of relatively low-bit rate communications (e.g., Bluetooth®). When only one device within the system falls within each category, the device ranking in terms of whether to offer broker services may be based on category. When multiple devices fall within a particular category, the relative ranks of the devices may be based on the other considerations described above.

### 8. Offering Broker Service Based on Number of Devices in System

Some examples of the devices are configured to determine whether to implement or operate a broker 2205, depending on the system configuration. For instance, some examples of the playback device 110, control device 130, etc., are configured to determine the number of brokers 2205 required to facilitate communications based on the number of devices operating in the system. Some examples of the devices are configured to determine the required number of brokers 2205 to be proportional to the number of devices operating in the system (e.g., one broker 2205 for every five playback devices). In some examples, the required number of brokers 2205 is predetermined and may be specified according to a table such as Table 2.

TABLE 2

| # of Players | # of Brokers |
|---|---|
| 1 | 1 |
| 2 | 2 |
| 3-7 | 3 |
| 8-15 | 4 |
| 16-31 | 5 |

Some examples of devices that offer brokering services are configured to determine whether it is necessary to continue offering broker services. For example, if a playback device 110 determines that there are more than enough brokers 2205 implemented in the system, the playback device 110 may cease offering broker services. Some examples of the devices make this determination based at least in part on the rank of their broker 2205 in comparison to the respective ranks of other brokers 2205 offering services within the system. In some examples, when there are more than enough brokers 2205 offering services, and the rank of the broker 2205 is lower than the respective ranks of some or all of the other brokers of the system, the device ceases offering brokering services. In some examples, prior to ceasing brokering services, the device communicates an indication that it will cease offering such services to devices that publish or subscribe to the broker of the device so that those devices may publish and subscribe to a different broker 2205. On the other hand, in some examples, when the rank of the playback device is higher than the respective rank of one or more of the other devices of the system, the device is configured to communicate an instruction to the other devices to cease offering brokering services.

### 9. Example Operations

FIGS. 10-14B illustrate examples of operations performed by one or more systems and/or devices described herein. The operations facilitate communicating information using the broker communication techniques described above. Some examples of the playback devices 110, control devices 130, etc., described herein are configured to perform these operations while simultaneously playing audio content and/or facilitating the playback of audio content. One or more of the operations may be implemented by instruction code stored within respective storage devices/memories of these devices, which is executable by one or more processors of the devices to configure the devices to perform these operations.

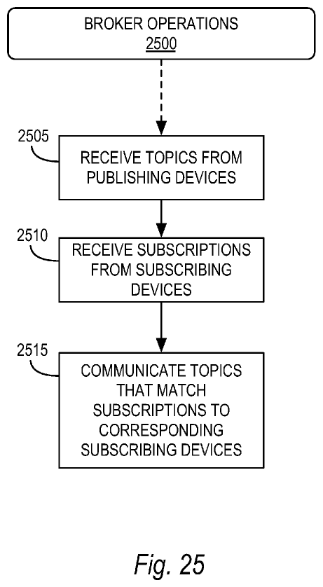

FIG. 25 illustrates examples of operations 2500 performed by a device when providing broker services. The operations at block 2505 involve receiving topics from one or more publishing devices 2210. Examples of the topics correspond to strings having a multi-level syntax such as “/Device/P1/Core/ModelNo=12345”. This topic specifies the model number for a device named P1. Other examples of topics that may be published by some examples playback devices 110 are described above (e.g., in Table 1).

The operations at block 2510 involve receiving subscriptions from one or more subscribing devices 2215. Examples of the subscriptions correspond to strings having a multi-level syntax such as “/Device/+/Core/ModelNo” (“+” being a wildcard).

The operations at block 2515 involve communicating topics that match the subscriptions to corresponding subscribing devices 2215. Following the example above, the subscription “/Device/+/Core/ModelNo” causes the broker 2205 to communicate the model number (more specifically, the topic that specifies the model number) for any devices that publish the model number using the same topic syntax to subscribing devices 2215. In another example, a subscription such as “/Device/P1/Core/#” (“#” being a wildcard) causes the broker 2205 to communicate all the core properties of device P1 to subscribing devices 2215. A subscription such as “/Device #” causes the broker 2205 to communicate all the properties of all devices (i.e., all properties of topics that begin with the term “Device”) to subscribing devices 2215.

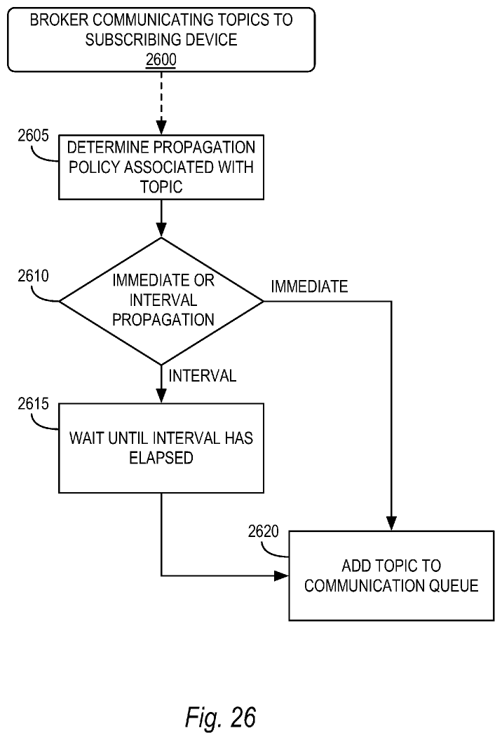

FIG. 26 illustrates examples of operations 2600 performed by a device when communicating topics to a subscribing device 2215. The operations 2600 facilitates controlling when topics are communicated to subscribing devices 2215. The operations at block 2605 involve determining the propagation policy associated with a topic. In this regard, some examples of the device may specify a propagation policy that indicates to the broker 2205 that a corresponding topic should be immediately propagated/communicated to subscribing devices 2215. The device may specify a propagation policy that indicates to the broker 2205 that a corresponding topic should be scheduled to be communicated to subscribing devices 2215 after a predetermined interval has elapsed. For example, the playback device 110 can specify a propagation policy that indicates that a topic such as “/Device/P1Props/NowPlaying=XYZ” should be communicated five seconds after being published.

If at block 2610, the propagation policy indicates immediate propagation of the topic, then the operations at 2620 are performed. The operations at 2620 involve adding the topic to a communication queue from which topics may be communicated to subscribing devices 2215. Afterward, the topic may be communicated after other topics that precede the topic in the queue have been communicated to subscribing devices 2215. In some examples, the propagation policy indicates a topic priority (e.g., 1 lowest, 10 highest) and the broker 2205 is configured to communicate topics in the queue having higher priorities before topics in the queue having lower priorities.

If at block 2610, the propagation policy indicates interval propagation or scheduled propagation of the topic, then the operations at 2615 are performed. The operations at block 2615 involve waiting until a corresponding interval has elapsed before adding the topic to the communication queue as described above in block 2620.

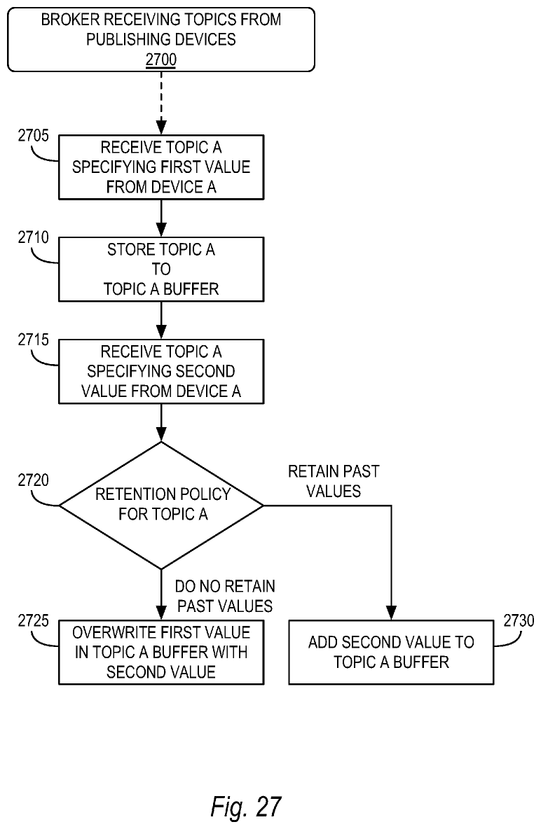

FIG. 27 illustrates examples of operations 2700 performed by a device when receiving topics from publishing devices 2210, which facilitate determining whether to communicate past topic values to subscribing devices 2215. The operations at block 2705 involve receiving a particular topic from a device, the topic specifying a particular value. For example, a particular playback device 110 may publish its initial volume level using the topic “/Device/P1/Props/Volume=10” and may also specify a retention policy that indicates non-retention of the topic. That is, a retention policy that indicates that past values for this topic should not be retained. The same playback device 110 may publish an indication of content being played using the topic “/Device/P1/Props/NowPlaying=XYZ” and also specify a retention policy that indicates retention of the topic. That is, a retention policy that indicates that past values for this topic should be retained or that a certain number of past values for this topic should be retained. The operations at block 2710 involve storing the topic received above in a topic buffer.

The operations at block 2715 involve receiving the same topic from the device a second time. However, the topic may specify a different value. For example, the playback device 110 above may publish a second volume level using the topic “/Device/P1/Props/Volume=15”. The playback device 110 may publish an indication of second content being played using the topic “/Device/P1/Props/NowPlaying=ABC”. The playback device 110 may specify retention policies as described above.

If at block 2720, the retention policy associated with the topic indicates that past values for this topic should not be retained, then the operations at block 2725 are performed. The operations at block 2725 involve overwriting the first value of the topic in the topic buffer with the second value. Thus, subscribing devices 2215 that subscribe to the topic after the first value was published to the broker 2205 will only receive the second value. In some examples, the first value is not actually overwritten. Rather, the first value is indicated as being stale and removable (e.g., via garbage collection process). In any event, the first value is not communicated.

If at block 2720, the retention policy associated with the topic indicates that past values for this topic should be retained or that a certain number of past values for this topic should be retained, then the operations at block 2730 are performed. The operations at block 2730 involve adding the second value to the topic buffer so that the topic buffer stores both the first value and the second value. Subscribing devices 2215 that subscribe to the topic after the first value was published to the broker 2205 will receive both the first value and the second value. In some examples, the first and second values are concatenated (e.g., into an array) into a single forwarded topic such as “/Device/P1/Props/NowPlaying={XYZ, ABC}.” In some examples, if only a certain number, N, values should be stored, then only N values are retained in the topic buffer.

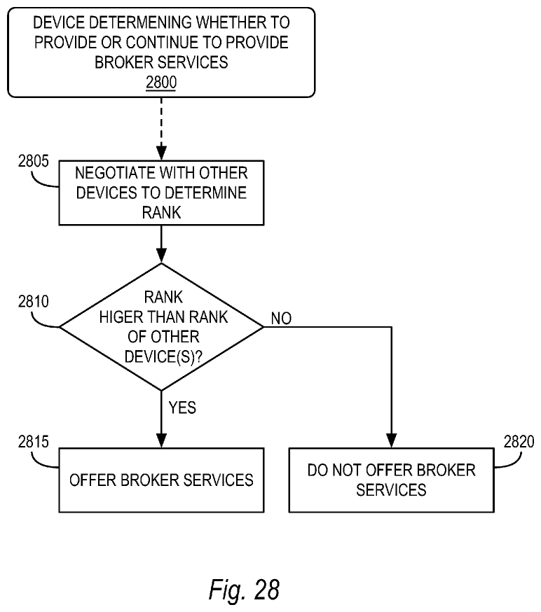

FIG. 28 illustrates examples of operations 2800 performed by a device when determining whether to provide or continue to provide broker services to other devices. As noted above, some systems may include a plurality of playback devices 110, and there may be more than one broker 2205 operating at the same time. The operations at block 2805 involve negotiating with other devices of the system to determine a broker rank. For example, the device may determine RSSI values associated with other devices that offer broker services, the number of hops required to communicate to the devices, the types of devices, the hardware capabilities of the devices, the available bandwidth of the devices to offer brokering services, etc. The other devices may perform similar operations. Based on these determinations, the devices may agree on a rank to assign to each device. As indicated above, each device can determine its own rank based on information acquired during the device negotiations, thus obviating the need for any centralized decision making. In some others examples, one of the devices can be designated as the decision maker and can specify the ranks to the other devices.

In some examples, the rank of the broker 2205 is determined based on the role the broker 2205 plays within a system. For example, a group of playback devices configured to operate in synchrony as part of a home theater system may each be capable of implementing a broker 2205. The center channel playback device may be configured to receive a stream of audio content from an audio source and to distribute appropriate audio content to the playback devices of the group. Given its centralized role, the broker 2205 of the center channel playback device may rank higher than the other playback device and, therefore, be used to broker information (e.g., state information) among the playback devices. In another example, a broker 2205 of a non-portable playback device is ranked higher than a broker 2205 of a portable playback device because the non-portable playback device may have a more reliable source of power or because the location of the playback device is relatively static.

If at block 2810, the rank of the device is higher than the rank of the other devices, then the operations at block 2815 are performed, and the device offers broker services.

If at block 2810, the rank of the device is not higher than the rank of the other brokers, then the operations at block 2820 are performed, and the device does not offer broker services.

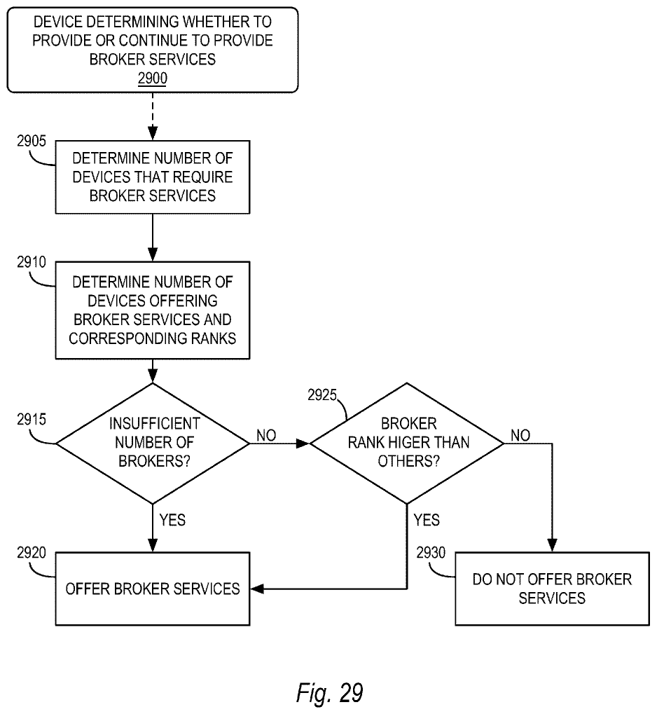

FIG. 29 illustrates examples of operations 2900 performed by a device when determining whether to provide or continue to provide broker services to other devices. The operations at block 2905 involve determining the number of playback devices 110 operating in a system that requires broker services. The operations at block 2910 involve determining the number of devices offering broker services and the corresponding ranks of those other devices. For instance, in some examples, the device determines the required number of required brokers 2205 to be proportional to the number of playback devices 110 operating in the system (e.g., one broker 2205 for every five playback devices). In some examples, the required number of brokers 2205 is predetermined and/or may be specified according to a table such as Table 2. The rank of the device and that of the other devices offering broker services may be determined as described above.

If at block 2915, there is an insufficient number of brokers, then the operations at block 2920 are performed, and the device offers broker services.

If at block 2915, the number of brokers 2205 is sufficient, and at block 2925, the rank of the device is higher than the rank of other devices offering broker services, then the operations at block 2920 are performed, and the device offers broker services. Otherwise, the operations at block 2930 are performed, and the device does not offer broker services.

The operations described above may be performed on a periodic basis (e.g., every 30 seconds) to provide fallback protection. For example, a particular device that had been offering broker services (e.g., a highest ranked broker) may become inoperative. In this case, at block 2915, one or more devices may determine that there are no longer a sufficient number of brokers. At block 2935, the ranks of the brokers are determined and/or negotiated among the devices, and at block 2920, the highest ranking of the device may offer broker services. If/when the issue with the original device is resolved, according to the operations above, the original device will begin offering brokering services, and the device that had taken over the broker services may cease to offer broker services as a result.

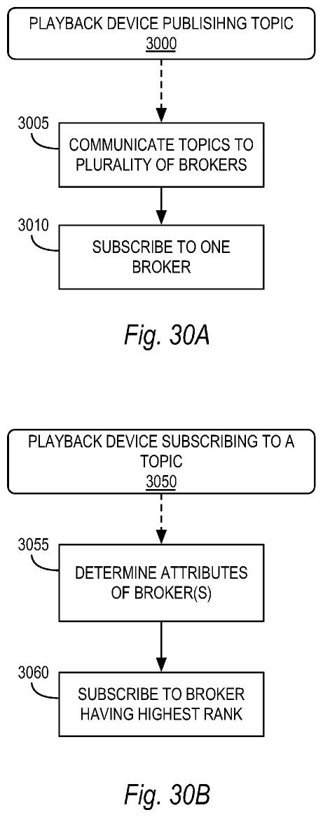

FIG. 30A illustrates examples of operations 3000 performed by a playback device 110 when publishing topics. The operations at block 3005 involve communicating topics to a plurality of brokers 2205 and the operations at block 3010 involve subscribing to a particular broker 2205. As noted above, in systems that include a plurality of playback devices 110 there may be more than one broker 2205 operating at the same time. When operating in such systems, the playback device 110 is configured to publish topics to more than broker 2205 and/or to subscribe to more than one broker 2205, as shown in FIG. 23C. The brokers 2205 to which the playback device 110 publishes and subscribes may be different. Publishing and/or subscribing to more than one broker 2205 provides a degree of redundancy in case one of the brokers 2205 were to go offline. For example, a particular playback device 110 may publish topics to a broker service operating on a portable playback device. The portable playback device 110 may move out of communication range, the battery may fully discharge, etc. By publishing and/or subscribing to a broker service on a second playback device, playback operations can continue uninterrupted.

FIG. 30B illustrates examples of operations 3050 performed by a playback device 110 when subscribing to topics. The operations at block 3005 involve receiving property from brokers 2205 and determining a broker rank associated with each broker 2205. In some examples, the rank is determined based at least in part on the received signal strength indication (RSSI) of the broker, a number of network device hops required to communicate information to the broker, hardware capabilities of the broker, the available bandwidth of the broker 2205 for offering brokering services, etc.

The operations at block 3060 involve subscribing to the broker 2205 associated with the highest rank. For example, the playback device 110 subscribes to the broker 2205 having the highest RSSI, etc.

### 10. Example Devices

As noted above, some examples of the devices described herein are configured to publish topics, subscribe to topics, and broker information. And some example devices are configured to perform and/or implement all of these aspects. For instance, an example of a device is configured to publish topics to a particular broker or to a plurality of brokers and to subscribe to a particular broker or to a plurality of brokers, as indicated in FIG. 30A. The device is configured to determine ranks associated with brokers and to subscribe to a broker or brokers having the highest rank, as indicated in FIG. 30B.

In some instances, the broker (or one of the brokers) to which topics are published and to which subscriptions are communicated corresponds a broker implemented by the device itself. In this regard, some examples of the broker implemented by the device are configured to receive topics and subscriptions from the device itself or other devices.

An example of the broker of the device is configured to perform the other operations described above. For example, as indicated in FIG. 26, the broker is configured to determine propagation policies associated with topics (e.g., immediate, interval, etc.) and to propagate those topics according to the policy.

As indicated in FIG. 27, the broker is configured to store topics to a buffer according to a retention policy that specifies whether to retain past values of topics. If topics are to be retained, the values of the topics are added to a topic buffer, and the values are communicated to devices that subscribe to the topic. This allows the subscribing device to obtain values that were published prior to the device subscribing to the topic.

As indicated in FIG. 28, the broker is configured to negotiate with other brokers to determine its rank and the rank of other brokers. If the rank of the broker implemented by the device is lower than the rank of one or more other brokers, the broker of the device may not be implemented. That is, broker services may not be provided by the device.

In this regard, as indicated in FIG. 29, multiple brokers may be required to support a networked group of devices of a particular size. In this case, the broker is configured to determine the number of required brokers and whether the number of brokers offering brokering services is sufficient. If the number of brokers is insufficient, the device implements the broker. On the other hand, if the number of brokers is sufficient and if the rank of the broker of the device is higher than the rank of the other brokers, the device implements the broker to offer brokering services. This may cause another, lower-ranked device offering broker services to cease offering broker services.

### 11. Additional Examples

Additional examples are disclosed in the clauses described below. The clauses are arranged within groups for clarity. It is understood that the examples set forth in the clauses of each group can be combined with the examples set forth in the other clauses of the group and the examples set forth in the clauses of each other group. Further, the examples set forth in the clauses can be combined with the other examples described herein.

### Group A

Clause 1. A device comprising:
one or more processors; and
one or more storage devices that comprise instruction code that is executable by at least one of the one or more processors to configure the device to:
operate as an information broker during a first period, wherein when the device operates as the information broker, the device is configured to:
receive, from a publishing device, topic data that specifies a topic name and a topic value, wherein the topic name specifies a particular property of the publishing device;
receive, from a subscribing device, subscription data that specifies at least one topic filter;
determine whether the at least one topic filter matches the topic data; and
after the at least one topic filter has been determined to match the topic data, communicate the topic data to the subscribing device; and
operate as an information subscriber during a second period, wherein when operating as the information subscriber, the device is configured to:
communicate, to another device that operates as an information broker, subscription data that specifies at least one topic filter; and
receive, from the other device that operates as the information broker, topic data that matches the subscription data.

Clause 2. The device according to clause 1, wherein the instruction code that is executable by the at least one of the one or more processors to configure the device to communicate the topic data to the subscribing device comprises instruction code that is executable by the at least one of the one or more processors to configure the device to:
operate as a publishing device during a third period, wherein when operating as the information subscriber, the device is configured to communicate topic data to another information broker, wherein the topic data specifies a particular property of the device.

Clause 3. The device according to clause 1, wherein the instruction code that is executable by the at least one of the one or more processors to configure the device to communicate the topic data to the subscribing device comprises instruction code that is executable by the at least one of the one or more processors to configure the device to:
determine a propagation category associated with the topic data;
after the propagation category is determined to indicate immediate propagation of the topic data, communicate the topic data to the subscribing device a nominal amount of time after the topic data has been received; and
after the propagation category has been determined to indicate interval propagation of the topic data, wait until after a predetermined interval has elapsed to communicate the topic data to the subscribing device.

Clause 4. The device according to clause 1, wherein the topic data corresponds to first topic data and wherein the instruction code is executable by the at least one of the one or more processors to configure the device to:
receive, from the publishing device, second topic data, wherein the second topic data specifies a topic name that is identical to the topic name in the first topic data and a topic value that is different from the topic value specified in the first topic data;
after the second topic data has been received, receive, from a second subscribing device, subscription data that specifies at least one topic filter that matches the first topic data and the second topic data;
determine a retention policy associated with the first topic data and the second topic data;
after the retention policy has been determined to indicate non-retention of topic data, communicate the second topic data to the second subscribing device instead of the first topic data; and
after the retention policy has been determined to indicate retention of topic data, communicate the first topic data and the second topic data to the second subscribing device.

Clause 5. The device according to clause 4, wherein the instruction code is executable by the at least one of the one or more processors to configure the device to:
store the first topic data to one of the one or more storage devices;
store the second topic data to the one of the one or more storage devices; and
after the retention policy has been determined to indicate non-retention of topic data, permit the first topic data to be removed from the one of the one or more storage devices.

Clause 6. The device according to clause 4, wherein the publishing device corresponds to a playback device, wherein the instruction code that is executable by the at least one of the one or more processors to configure the device to determine a retention policy associated with the first topic data and the second topic data comprises instruction code that is executable by the at least one of the one or more processors to configure the device to:
determine the retention policy to indicate non-retention of topic data when the particular property specified in the topic data corresponds to one of: a volume level of the playback device, a playback state of the playback device, a group membership of the playback device, a model number of the playback device, and a calibration state of the playback device; and
determine the retention policy to indicate retention of topic data when the particular property specified in the topic data corresponds to one of: metadata associated with content played on the playback device, and a room location of the playback device.

Clause 7. The device according to clause 1, wherein the topic name has a multi-level syntax and the topic filter has a multi-level syntax.

Clause 8. The device according to clause 1, wherein the topic filter comprises one or more wildcards.

Clause 9. The device according to clause 1, wherein the topic name comprised within the topic data uniquely identifies the publishing device within a networked environment of publishing devices.

Clause 10. The device according to clause 1, wherein the device is a first device and is in network communication with a second device configured to operate as an information broker, wherein the instruction code is executable by the at least one of the one or more processors to configure the first device to:
receive, from the second device, information that specifies one or more attributes of the second device;
determine a broker rank of the first device and a broker rank of the second device based on a comparison of the one or more attributes of the first device with corresponding properties of the second device;
after the broker rank of the first device has been determined to be higher than the broker rank of the second device, operate as an information broker that communicates the topic data from the publishing device to the subscribing device; and
after the broker rank of the first device has been determined to be lower than the broker rank of the second device, allow the second device to operate as the information broker that communicates the topic data from the publishing device to the subscribing device.

Clause 11. The device according to clause 10, wherein the one or more attributes correspond to one or more of: respective types of the first device and the second device, respective storage capacities of the first device and the second device, respective locations of the first device and the second device, and respective network identifiers of the first device and second device.

Clause 12. The device according to clause 1, wherein the publishing device is a first playback device and the subscribing device is a second playback device, wherein the topic data communicated from the first playback device to the second playback device when the device is operating as the information broker facilitates synchronized playback of audio content between the first playback device and the second playback device.

Clause 13. A non-transitory computer-readable medium that comprises instruction code executable by at least one of one or more processors of a computing system, wherein the instruction code configures the computing system to:
operate as an information broker during a first period, wherein when the computing system operates as the information broker, the computing system is configured to:
receive, from a publishing device, topic data that specifies a topic name and a topic value, wherein the topic name specifies a particular property of the publishing device;
receive, from a subscribing device, subscription data that specifies at least one topic filter;
determine whether the at least one topic filter matches the topic data; and
after the at least one topic filter has been determined to match the topic data, communicate the topic data to the subscribing device; and
operate as an information subscriber during a second period, wherein when operating as the information subscriber, the computing system is configured to:
communicate, to another computing system that operates as an information broker, subscription data that specifies at least one topic filter; and
receive, from the other computing system that operates as the information broker, topic data that matches the subscription data.

Clause 14. The transitory computer-readable medium according to clause 13, wherein the instruction code that is executable by the at least one of the one or more processors to configure the computing system to communicate the topic data to the subscribing device comprises instruction code that is executable by the at least one of the one or more processors to configure the computing system to:
operate as a publishing device during a third period, wherein when operating as the information subscriber, the computing system is configured to communicate topic data to another information broker, wherein the topic data specifies a particular property of the computing system.

Clause 15. The transitory computer-readable medium according to clause 13, wherein the instruction code that is executable by the at least one of the one or more processors to configure the computing system to communicate the topic data to the subscribing device comprises instruction code that is executable by the at least one of the one or more processors to configure the computing system to:
determine a propagation category associated with the topic data;
after the propagation category is determined to indicate immediate propagation of the topic data, communicate the topic data to the subscribing device a nominal amount of time after the topic data has been received; and
after the propagation category has been determined to indicate interval propagation of the topic data, wait until after a predetermined interval has elapsed to communicate the topic data to the subscribing device.

Clause 16. The transitory computer-readable medium according to clause 13, wherein the topic data corresponds to first topic data and wherein the instruction code is executable by the at least one of the one or more processors to configure the computing system to:
receive, from the publishing device, second topic data, wherein the second topic data specifies a topic name that is identical to the topic name in the first topic data and a topic value that is different from the topic value specified in the first topic data;
after the second topic data has been received, receive, from a second subscribing device, subscription data that specifies at least one topic filter that matches the first topic data and the second topic data;
determine a retention policy associated with the first topic data and the second topic data;
after the retention policy has been determined to indicate non-retention of topic data, communicate the second topic data to the second subscribing device instead of the first topic data; and
after the retention policy has been determined to indicate retention of topic data, communicate the first topic data and the second topic data to the second subscribing device.

Clause 17. The transitory computer-readable medium according to clause 16, wherein the instruction code is executable by the at least one of the one or more processors to configure the computing system to:
store the first topic data to one or more storage devices of the computing system;
store the second topic data to the one or more storage devices of the computing system; and
after the retention policy has been determined to indicate non-retention of topic data, permit the first topic data to be removed from the one or more storage devices of the computing system.

Clause 18. The transitory computer-readable medium according to clause 16, wherein the publishing device corresponds to a playback device, wherein the instruction code that is executable by the at least one of the one or more processors to configure the computing system to determine a retention policy associated with the first topic data and the second topic data comprises instruction code that is executable by the at least one of the one or more processors to configure the computing system to:
determine the retention policy to indicate non-retention of topic data when the particular property specified in the topic data corresponds to one of: a volume level of the playback device, a playback state of the playback device, a group membership of the playback device, a model number of the playback device, and a calibration state of the playback device; and
determine the retention policy to indicate retention of topic data when the particular property specified in the topic data corresponds to one of: metadata associated with content played on the playback device, and a room location of the playback device.

Clause 19. The transitory computer-readable medium according to clause 13, wherein the topic name has a multi-level syntax and the topic filter has a multi-level syntax, wherein the topic name uniquely identifies the publishing device within a networked environment of publishing devices.

Clause 20. The transitory computer-readable medium according to clause 19, wherein the computing system is a first computing system and is in network communication with a second computing system configured to operate as an information broker, wherein the instruction code is executable by the at least one of the one or more processors to configure the first computing system to:
receive, from the second computing system, information that specifies one or more attributes of the second computing system;
determine a broker rank of the first computing system and a broker rank of the second computing system based on a comparison of the one or more attributes of the first computing system with corresponding properties of the second computing system;
after the broker rank of the first computing system has been determined to be higher than the broker rank of the second computing system, operate as an information broker that communicates the topic data from the publishing device to the subscribing device; and
after the broker rank of the first computing system has been determined to be lower than the broker rank of the second computing system, allow the second computing system to operate as the information broker that communicates the topic data from the publishing device to the subscribing device.

### Group B

Clause 1. A device comprising:
one or more processors; and
one or more storage devices that comprise instruction code executable by at least one of the one or more processors to configure the device to:
determine a number of devices operating in a networked environment;
after the number of devices has been determined, determine a required number of brokers that should be implemented amongst the devices to facilitate communications between the devices, wherein each broker is configured to i) receive topic data from one or more devices that publish topic data to the broker and ii) communicate the topic data to one or more devices that have subscribed to the broker to receive the topic data; and
after determining that the number of required brokers is less than an implemented number of brokers, implement a broker on the device.

Clause 2. The device according to clause 1, wherein the instruction code that is executable by the at least one of the one or more processors to determine the number of required brokers that should be implemented among the devices to facilitate communications between the devices comprises instruction code that is executable by the at least one of the one or more processors to configure the device to:
determine the number of required brokers to be proportional to the number of devices operating in the networked environment.

Clause 3. The device according to clause 1, wherein the instruction code is executable by the at least one of the one or more processors to configure the device to:
when the device implements a broker, determine a rank of the broker; and
after the implemented number of brokers has been determined to be greater than the required number of brokers and the rank of the broker has been determined to be lower than respective ranks of at least a number of implemented brokers that corresponds to a number of required brokers, ceasing implementation of the broker.

Clause 4. The device according to clause 1, wherein the instruction code is executable by the at least one of the one or more processors to configure the device to:
when the device implements a broker, determine a rank of the broker; and
after the implemented number of brokers has been determined to be greater than the required number of brokers and the rank of the broker has been determined to be higher than a rank of at least one implemented brokers, communicate an instruction to a device associated with the at least one of the implemented broker to cease implementation of the at least one of the implemented broker.

Clause 5. The device according to clause 1, wherein the instruction code is executable by the at least one of the one or more processors to configure the device to:
communicate topic data associated with the device to a plurality of brokers implemented by a corresponding plurality of devices in the networked environment; and
subscribe to a broker implemented by a particular device to receive topic data associated with other devices.

Clause 6. A device according to clause 5, wherein the instruction code is that is executable by the at least one of the one or more processors to configure the device to subscribe to a broker of a particular device to receive topic data associated with other devices comprises instruction code that is executable by the at least one of the one or more processors to configure the device to:
determine respective ranks of the plurality of brokers based on a comparison of one or more attributes of the corresponding plurality of devices; and
subscribe to a broker implemented by a device associated with a highest rank to receive topic data associated with other devices.

Clause 7. The device according to clause 6, wherein the one or more attributes of the corresponding plurality of devices correspond to one or more of: respective received signal strengths of the corresponding plurality of devices, respective number of network device hops required to communicate information to the corresponding plurality of devices, and respective types of the corresponding plurality of devices.

Clause 8. The device according to clause 5, wherein:
the topic data specifies a topic name and a topic value and wherein the topic name specifies a particular property of the device that facilitates synchronized playback of audio content with other devices operating in the networked environment.

Clause 9. The device according to clause 5, wherein the instruction code that is executable by the at least one of the one or more processors to configure the device to subscribe to a broker implemented by a device comprises instruction code that is executable by the at least one of the one or more processors to configure the device to:
communicate a subscription that specifies at least one topic filter to the broker implemented by the device.

Clause 10. A device comprising:
one or more processors; and
one or more storage devices that comprise instruction code executable by at least one of the one or more processors to configure the device to implement a broker and configure the broker to:
receive topic data from the device, wherein the topic data specifies a topic name and a topic value and wherein the topic name specifies a particular property of the device that facilitates synchronized playback of audio content with one or more other devices;
communicate the topic data to one or more of the one or more other devices that have subscribed to the topic data;
communicate to respective brokers of one or more of the one or more other devices, a subscription that specifies at least one topic filter that matches topic data published by respective brokers of the one or more of the one or more other devices that facilitates synchronized playback of audio content with the one or more of the one or more other devices.

Clause 11. The device according to clause 10, wherein the instruction code that is executable by the at least one of the one or more processors to configure the broker to communicate the topic data to one or more of the one or more other devices that have subscribed to the topic data, comprises instruction code that is executable by the at least one of the one or more processors to configure the broker to:
receive, from the one or more of the one or more other devices, respective subscription packets that specify at least one topic filter;
determine whether the at least one topic filter matches the topic data; and
after the at least one topic filter has been determined to match the topic data, communicate the topic data to the one or more of the one or more other devices to configure the one or more of the one or more other devices to the audio content in synchrony with the device.

Clause 12. A non-transitory computer-readable medium that comprises instruction code executable by one or more processors of a device, wherein the instruction code configures the device to:
determine a number of devices operating in a networked environment;
after the number of devices has been determined, determine a required number of brokers that should be implemented amongst the devices to facilitate communications between the devices, wherein each broker is configured to i) receive topic data from one or more devices that publish topic data to the broker and ii) communicate the topic data to one or more devices that have subscribed to the broker to receive the topic data; and
after determining that the number of required brokers is less than an implemented number of brokers, implement a broker on the device.

Clause 13. The non-transitory computer-readable medium according to clause 12, wherein the instruction code that is executable by the at least one of the one or more processors to determine the number of required brokers that should be implemented among the devices to facilitate communications between the devices comprises instruction code that is executable by the at least one of the one or more processors to configure the device to:
determine the number of required brokers to be proportional to the number of devices operating in the networked environment.

Clause 14. The non-transitory computer-readable medium according to clause 12, wherein the instruction code is executable by the at least one of the one or more processors to configure the device to:
when the device implements a broker, determine a rank of the broker; and
after the implemented number of brokers has been determined to be greater than the required number of brokers and the rank of the broker has been determined to be lower than respective ranks of at least a number of implemented brokers that corresponds to a number of required brokers, ceasing implementation of the broker.

Clause 15. The non-transitory computer-readable medium according to clause 12, wherein the instruction code is executable by the at least one of the one or more processors to configure the device to:
when the device implements a broker, determine a rank of the broker; and
after the implemented number of brokers has been determined to be greater than the required number of brokers and the rank of the broker has been determined to be higher than a rank of at least one implemented brokers, communicate an instruction to a device associated with the at least one of the implemented broker to cease implementation of the at least one of the implemented broker.

Clause 16. The non-transitory computer-readable medium according to clause 12, wherein the instruction code is executable by the at least one of the one or more processors to configure the device to:
communicate topic data associated with the device to a plurality of brokers implemented by a corresponding plurality of devices in the networked environment; and
subscribe to a broker implemented by a particular device to receive topic data associated with other devices.

Clause 17. A non-transitory computer-readable medium according to clause 16, wherein the instruction code is that is executable by the at least one of the one or more processors to configure the device to subscribe to a broker of a particular device to receive topic data associated with other devices comprises instruction code that is executable by the at least one of the one or more processors to configure the device to:
determine respective ranks of the plurality of brokers based on a comparison of one or more attributes of the corresponding plurality of devices; and
subscribe to a broker implemented by a device associated with a highest rank to receive topic data associated with other devices.

Clause 18. The non-transitory computer-readable medium according to clause 17, wherein the one or more attributes of the corresponding plurality of devices correspond to one or more of: respective received signal strengths of the corresponding plurality of devices, respective number of network device hops required to communicate information to the corresponding plurality of devices, and respective types of the corresponding plurality of devices.

Clause 19. The non-transitory computer-readable medium according to clause 16, wherein:
the topic data specifies a topic name and a topic value and wherein the topic name specifies a particular property of the device that facilitates synchronized playback of audio content with other devices operating in the networked environment.

Clause 20. The non-transitory computer-readable medium according to clause 17, wherein the instruction code that is executable by the at least one of the one or more processors to configure the device to subscribe to a broker implemented by a device comprises instruction code that is executable by the at least one of the one or more processors to configure the device to:
communicate a subscription that specifies at least one topic filter to the broker implemented by the device.

### V. Conclusions

The above discussions relating to playback devices, controller devices, playback zone configurations, and media/audio content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain specific details. In other instances, well-known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1-22. (canceled)

23. A system comprising a plurality of playback devices, wherein each playback device comprises:
one or more processors; and
one or more storage devices that comprise instruction code that is executable by at least one of the one or more processors,
wherein instruction code executed by one or more processors of a particular primary playback device (PPD) causes the particular PPD to:
receive state information from a particular secondary playback device (SPD), wherein the state information specifies a state associated with at least one aspect of the particular SPD, and
after receiving a subscription from one or more other PPDs for the state of the particular aspect of the particular SPD, communicate the state information that specifies the state of the particular aspect of the particular SPD to the one or more other PPDs.

24. The system according to claim 23, further comprising a plurality of PPDs, wherein the instruction code that causes the particular PPD to communicate the state information to one or more other PPDs causes the particular PPD to:
communicate the state information that specifies the state of the particular aspect of the particular SPD to every PPD of the plurality of PPDs.

25. The system according to claim 23, wherein instruction code executed by one or more processors of the particular SPD causes the particular SPD to:
after the state of the particular aspect of the SPD has changed, communicate the state information that specifies the state of the particular aspect of the SPD to the PPD.

26. The system according to claim 23, wherein the instruction code executed by the one or more processors of the particular PPD causes the particular PPD to:
receive a subscription from the particular SPD for the state associated with a particular aspect of one or more other playback devices;
communicate a subscription to one or more other PPDs for the state associated with the particular aspect of the one or more other playback devices;
receive the state information associated with the subscription from the one or more other PPDs; and
communicate the state information to the particular SPD.

27. The system according to claim 23, further comprising:
a plurality of PPDs; and
a plurality of SPDs, wherein each PPD of the plurality of PPDs is grouped with a different subset of the plurality of SPDs, and wherein the PPD of each group communicates timing information to the SPDs of the group to facilitate playback of audio content on the playback devices of the group in synchrony.

28. The system according to claim 23, wherein the state information comprises a multilevel syntax that specifies the at least one aspect of the particular SPD and a corresponding state of the at least one aspect, and wherein the subscription comprises a multilevel syntax that specifies the particular aspect for which the state is desired.

29. The system according to claim 28, wherein the multilevel syntax comprises one or more wildcards.

30. The system according to claim 29, wherein the multilevel syntax uniquely identifies a particular playback device.

31. The system according to claim 23, wherein each of the plurality of devices specifies different categories of state information, wherein a first category of state information of each of the plurality of devices is propagated to each other playback device of the plurality of playback devices via the particular PPD and the one or more other PPDs.

32. The system according to claim 31, wherein the first category of state information specifies a network address of a playback device.

33. The system according to claim 31, wherein a second category of state information of each of the plurality of devices is propagated only to the particular PPD and the one or more other PPDs.

34. The system according to claim 33, wherein the second category of state information specifies a battery level of a playback device.

35. A system comprising a plurality of playback devices, wherein each playback device comprises:
one or more processors; and
one or more storage devices that comprise instruction code that is executable by at least one of the one or more processors,
wherein instruction code executed by one or more processors of a particular primary playback device (PPD) causes the particular PPD to:
receive state information from a particular secondary playback device (SPD), wherein the state information specifies a state associated with at least one aspect of the particular SPD, and
after receiving a subscription from one or more global state aggregation devices (GSADs) for the state of the particular aspect of the particular SPD, communicate the state information that specifies the state of the particular aspect of the particular SPD to the one or more GSADs,
wherein instruction code executed by one or more processors of the one or more GSADs causes the one or more GSADs to:
after receiving a subscription from one or more other GSADs for the state of the particular aspect of the particular SPD, communicate the state information to the one or more other GSADS.

36. The system according to claim 35, further comprising a plurality of GSADs, wherein the instruction code that causes the one or more GSADs to communicate the state information to the one or more other GSADs causes the one or more GSADs to:
communicate the state information that specifies the state of the particular aspect of the particular SPD to every GSAD of the plurality of GSADs.

37. The system according to claim 35, wherein the instruction code executed by the one or more processors of the particular PPD causes the particular PPD to:
after receiving a subscription from the particular SPD for the state associated with a particular aspect of another playback device, communicate the subscription to the one or more GSADs, and
after receiving state information from the one or more GSADs associated with the subscription, communicate the state information to the particular SPD.

38. The system according to claim 35, further comprising:
a plurality of PPDs; and
a plurality of GSADs, wherein every GSAD of the plurality of GSADs communicates subscriptions to every PPD of the plurality of the PPDs and every PPD of the plurality of the PPDs communicates subscriptions to every GSAD of the plurality of GSADs.

39. The system according to claim 35, further comprising:
a plurality of PPDs; and
a plurality of GSADs, wherein every GSAD of the plurality of GSADs communicates subscriptions to every other GSAD of the plurality of GSADs and each PPD of the plurality of the PPDs communicates subscriptions to a single GSAD of the plurality of GSADs.

40. The system according to claim 35, wherein a first plurality of playback devices are capable of simultaneously operating as both a PPD and a GSAD, wherein the instruction code executed by one or more processors of a particular playback device of the first plurality of playback devices causes the particular playback device to:
determine a rank based on one or more attributes of the particular playback device;
after the rank of the particular playback device is determined to be higher than a rank of a second playback device of the first plurality of playback devices, operate as a GSAD; and
after the rank of the particular playback device is determined to be lower than the rank of the second playback device, operate as a PPD and allow the second playback device to operate as a GSAD.

41. The system according to claim 40, wherein the one or more playback device attributes correspond to one or more of: a type of the particular playback device, a storage capacity of the playback device, a location of the particular playback device, and a network identifier of the particular playback device.

42. A playback device comprising:
one or more processors; and
one or more storage devices that comprise instruction code that is executable by at least one of the one or more processors,
wherein the playback device corresponds to a primary playback device (PPD) and wherein instruction code executed by one or more processors of the playback device causes the playback device to:
receive state information from a particular secondary playback device (SPD), wherein the state information specifies a state associated with at least one aspect of the particular SPD, and
after receiving a subscription from one or more other PPDs for the state of the particular aspect of the particular SPD, communicate the state information that specifies the state of the particular aspect of the particular SPD to the one or more other PPDs.
